(19) United States
(12) Patent Application Publication
(10) Pub. No.: US 2015/0232697 A1
(43) Pub. Date: Aug. 20, 2015

(54) SOLUTION OF AROMATIC POLYAMIDE FOR PRODUCING DISPLAY ELEMENT, OPTICAL ELEMENT, ILLUMINATION ELEMENT OR SENSOR ELEMENT

(71) Applicants: AKRON POLYMER SYSTEMS, INC., Akron, OH (US); SUMITOMO BAKELITE CO., LTD., Shinagawa-ku (JP)

(72) Inventors: Limin SUN, Copley, OH (US); Dong Zhang, Uniontown, OH (US); Frank W. Harris, Boca Raton, FL (US); Hideo Umeda, Kobe-shi (JP); Ritsuya Kawasaki, Kobe-shi (JP); Toshihiko Katayama, Nishinomiya-shi (JP); Yusuke Inoue, Kobe-shi (JP); Jun Okada, Kobe-shi (JP); Mizuho Inoue, Kobe-shi (JP); Manabu Naito, Kobe-shi (JP)

(73) Assignees: AKRON POLYMER SYSTEMS, INC., Akron, OH (US); SUMITOMO BAKELITE CO., LTD., Shinagawa-ku (JP)

(21) Appl. No.: 14/626,440

(22) Filed: Feb. 19, 2015

Related U.S. Application Data
(60) Provisional application No. 61/942,374, filed on Feb. 20, 2014.
(60) Provisional application No. 62/027,967, filed on Jul. 23, 2014.

(51) Int. Cl. C09D 177/06; C03C 23/00; C03C 17/32

(52) U.S. Cl. CPC C09D 177/06; C03C 17/32; C03C 23/007

(57) ABSTRACT

In an aspect, the present disclosure relates to a polyamide solution including aromatic polyamide and a solvent. A dimension change gap between a cast film of the polyamide solution and the cast film after being subjected to a heat treatment is not more than a predetermined value. In another aspect, the present disclosure relates to a method for manufacturing a display element, an optical element, an illumination element or a sensor element, including a step of forming a polyamide film by using the polyamide solution.

### CROSS-REFERENCE TO RELATED APPLICATION

The disclosure is based upon and claims priority from U.S. Provisional Application Ser. No. 61/942,374 and U.S. Provisional Application Ser. No. 62/027,967, the disclosures of which are hereby incorporated by reference herein in its entirety.

### TECHNICAL FIELD

The present disclosure, in one aspect, relates to a polyamide solution including an aromatic polyamide and a solvent. A dimension change gap between a cast film of the polyamide solution and the cast film after being subjected to a heat treatment is not more than a predetermined value. The present disclosure, in another aspect, relates to a laminated composite material including a glass plate and a polyamide resin layer, wherein the polyamide resin layer is laminated on one surface of the glass plate. The polyamide resin layer is obtained by applying the polyamide solution onto the glass plate. The present disclosure, in another aspect, relates to a method for manufacturing a display element, an optical element, an illumination element or a sensor element, including a step of forming a polyamide film using the polyamide solution.

### BACKGROUND ART

As transparency is required for display elements, glass substrates using glass plates have been used as substrates for the elements (JP10311987 (A)). However, for display elements using glass substrates, problems such as being heavy in weight, breakable and unbendable have been pointed out at times. Thus, use of a transparent resin film instead of a glass substrate has been proposed.

Further, as a substrate for the sensor element to be used for an input device such as an image pickup device, a glass plate, an inorganic substrate such as YSZ, a resin substrate and a composite material thereof is used (JP2014-3244 (A)). A substrate for a sensor element, which is to be disposed at the light-receiving side, is required to have transparency.

For example, polycarbonates, which have high transparency, are known as transparent resins for use in optical applications. However, their heat resistance and mechanical strength may not be sufficient to be used for manufacturing display elements. On the other hand, examples of heat resistant resins include polyimides. However, typical polyimides are brown-colored, and thus it may not be suitable for use in optical applications. As polyimides with transparency, those having a ring structure are known. However, the problem with such polyimides is that they have poor heat resistance.

For polyamide films for use in optical applications, WO 2004/039863 and JP 2008260266(A) each discloses an aromatic polyamide having diamine including a trifluoro group, which provides both high stiffness and heat resistance.

WO 2012/129422 discloses a transparent polyamide film with thermal stability and dimension stability. This transparent film is manufactured by casting a solution of aromatic polyamide and curing at a high temperature. The document discloses that the cured film has a transmittance of more than 80% over a range of 400 to 750 nm, a coefficient of thermal expansion (CTE) of less than 20 ppm/° C., and shows favorable solvent resistance. And the document discloses that the film can be used as a flexible substrate for a microelectronic device.

### SUMMARY

The present disclosure, in one aspect, relates to a polyamide solution comprising an aromatic polyamide and a solvent, wherein a dimension change gap between a cast film produced by casting the polyamide solution on a glass plate and the cast film after being subjected to a heat treatment is −50 μm to 50 μm.

The present disclosure, in another aspect, relates to a laminated composite material, comprising a glass plate and a polyamide resin layer; wherein the polyamide resin layer is laminated on one surface of the glass plate; wherein the polyamide resin is a polyamide resin formed by casting the polyamide solution according to the present disclosure on a glass plate.

In one or a plurality of embodiments, the present disclosure, in another aspect, relates to a method for manufacturing a display element, an optical element, an illumination element or a sensor element, comprising the steps of a) applying the polyamide solution according to the present disclosure onto a base; b) forming a polyamide film on the base after the applying step (a); and c) forming the display element, the optical element or the illumination element, or the sensor element, on the surface of the polyamide film.

### BRIEF DESCRIPTION OF DRAWINGS

FIG. 1 is a flow chart for explaining a method for manufacturing an OLED element or a sensor element according to one embodiment.

FIG. 2 is a flow chart for explaining a method for manufacturing an OLED element or a sensor element according to one embodiment.

FIG. 3 is a flow chart for explaining a method for manufacturing an OLED element or a sensor element according to one embodiment.

FIG. 4 is a schematic cross-sectional view showing a configuration of an organic EL element 1 according to one embodiment.

FIG. 5 is a schematic cross-sectional view showing a sensor element 10 according to one embodiment.

### DETAILED DESCRIPTION

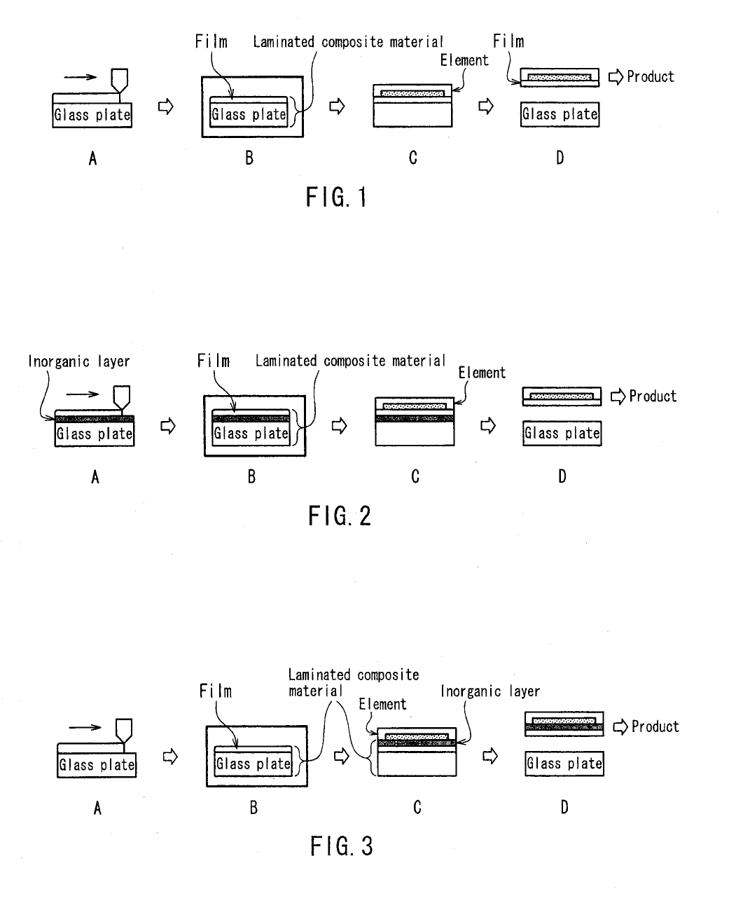

A display element, an optical element, or an illumination element such as an organic electro-luminescence (OEL) or organic light-emitting diode (OLED) is often produced by the method as described in FIG. 1. Briefly, a polymer solution (varnish) is applied or casted onto a glass base or a silicon wafer base (step A), the applied polymer solution is cured to form a film (step B), an element such as OLED is formed on the film (step C), and then, the element such as OLED (product) is de-bonded from the base (step D). These days, polyimide film is used as the film in the method in FIG. 1.

A sensor element used for an input device such as an image pickup device also is manufactured often by the process described in FIG. 1. Briefly, a polymer solution (varnish) is applied onto a base (glass or silicon wafer) (step A), the applied polymer solution is cured to form a film (step B), a sensor element are formed on the film (step C), and then, the sensor element is de-bonded from the base (step D).

In the method for manufacturing the display element, the optical element, the illumination element or the sensor element as illustrated in FIG. 1, there has been found a problem that, even when no warpage occurs in the laminated composite material including the glass plate and the film obtained in the step B, warpage deformation occurs in the heat treatment in the step of forming elements such as OLED or the sensor element in the step C, which degrades the quality and the yield. Namely, when warpage deformation occurs in the laminated composite material, conveyance during a manufacturing process will be difficult. In addition, as the exposure intensity changes during a patterning production, production of uniform pattern would be difficult, and/or cracks would develop easily in a case of laminating an inorganic barrier layer.

The present disclosure has a basis on a finding that in one or a plurality of embodiments, an aim of suppressing warpage deformation that can occur in the step C of FIG. 1, i.e., suppressing warpage deformation caused by the heat treatment (for example, heat treatment at temperature of 200° C. to 450° C.) in the steps of manufacturing the elements or the like after manufacturing the laminated composite material can be achieved by use of a polyamide solution that can decrease the dimension change gap before and after treating the cast film with heat. That is, by reducing the thermal hysteresis of the polyamide film rather than the difference in CTE between the glass plate and the polyamide film, warpage in the laminated composite material can be suppressed more effectively.

Therefore, in an aspect, the present disclosure relates to a polyamide solution that includes an aromatic polyamide and a solvent, wherein a dimension change gap between a cast film manufactured by casting the polyamide solution on a glass plate and the cast film after being subjected to a heat treatment is −50 μm to 50 μm. Further, in an aspect, the present disclosure relates to a polyimide solution that is capable of suppressing warpage deformation of a laminated composite material in a step of manufacturing elements such as a display element, an optical element, an illumination element and a sensor element.

In one or a plurality of embodiments, the term “a cast film manufactured by casting a polyamide solution on a glass plate” refers to a film obtained by applying the polyamide solution according to the present disclosure onto a flat glass base, and drying, and if necessary curing, the applied solution. In one or a plurality of embodiments, the cast film refers to a film manufactured by the film formation method disclosed in Examples. In one or a plurality of non-limiting embodiments, thickness of the cast film is 7 μm to 12 μm, 9 μm to 11 μm, about 10 μm or 10 μm.

In the present disclosure, “dimension change gap” refers to a difference in dimension between a cast film produced by casting a polyamide solution according to the present disclosure on a glass plate and the film after being subjected to a heat treatment. In one or a plurality of embodiments, the heat treatment includes heating and cooling. In one or a plurality of embodiments, the heat treatment may include heating to a predetermined temperature, keeping a predetermined temperature for a predetermined time period, and cooling to a temperature of a level before the treatment. In one or a plurality of embodiments, the “dimension change gap” refers to a dimensional change of a sample film after being subjected to at least one cycle measurement including heating and cooling. In one or a plurality of embodiments, the temperature in the heat treatment is an ambient temperature around the film. In one or a plurality of embodiments, the dimension change gap is measured by a thermal mechanical analysis (TMA). In one or a plurality of embodiments, the dimension change gap can be measured by a method disclosed in Examples.

In the present disclosure, in one or a plurality of embodiments, “temperature of heat treatment” refers to the temperature after heating in the heat treatment and/or the temperature kept for a predetermined time period after the heating. In one or a plurality of embodiments, the temperature of the heat treatment is equal to or higher than the “temperature deducted 100° C. from the glass transition temperature of the cast film”. It is equal to or higher than the “temperature deducted 90° C. from the glass transition temperature of the cast film, equal to or higher than the temperature deducted 80° C. from the glass transition temperature of the cast film, or, equal to or higher than the “temperature deducted 70° C. from the glass transition temperature of the cast film. In one or a plurality of embodiments, the temperature of the heat treatment is lower than the glass transition temperature of the cast film. In one or a plurality of embodiments, the temperature of the heat treatment is 200° C. to 450° C.

In the present disclosure, in the heat treatment, the time period for keeping the “temperature of heat treatment” is, in one or a plurality of embodiments, 3 to 20 minutes, 4 to 10 minutes, 4 to 6 minutes, or 5 minutes. The pace for warming or cooling is, in one or a plurality of non-limiting embodiments, may be 10° C. to 30° C., 15° C. to 25° C., or 20° C. in a minute. The temperature before the heat treatment (before warming) is, in one or a plurality of non-limiting embodiments, may be room temperature, average temperature, or 25° C. to 37° C.

[Dimension Change Gap]

The polyamide solution according to the present disclosure causes the dimension change gap in the range of −50 μm to 50 μm. In one or a plurality of embodiments, the dimension change gap is in the range of −40 μm to 40 μm, −30 μm to 30 μm, −20 μm to 20 μm, or, −15 μm to 15 μm.

In one or a plurality of embodiments, the present disclosure is based on a finding that there is a correlation between the amount of warpage deformation and the dimension change gap of the laminated composite material in the steps of manufacturing the elements such as the display element, the optical element, the illumination element, the sensor element and the like. That is, by reducing the dimension change gap, the warpage deformation can be suppressed.

[tan δ of β Relaxation Peak]

In one or a plurality of embodiments, an example of the polyamide solution to reduce the dimension change gap is a polyamide solution with a smaller tan δ of β relaxation peak expressed in a region of a lower temperature in comparison with the α relaxation of a cast film manufactured by casting on a glass plate. Here in one or a plurality of embodiments, “β relaxation” is regarded as being caused by movement of small clusters like the side chains of a polymer (see ‘Similarity between Transition of Crack Pattern in Powder Solid and Glass Transition’ Search Report by Kanagawa Industrial Technology Center, No. 14/2008).

In the present disclosure, in one or a plurality of embodiments, “tan δ of β relaxation peak” can be measured with a dynamic mechanical analyzer (DMA). In one or a plurality of embodiments, the tan δ of β relaxation peak can be measured by the method disclosed in Examples.

In one or a plurality of embodiments, the tan δ of β relaxation peak of the polyamide solution according to the present disclosure is 0.15 or less, 0.12 or less, 0.10 or less, 0.08 or less, 0.07 or less, or, 0.05 or less.

[Glass Transition Temperature (Tg)]

In one or a plurality of embodiments, regarding the polyamide solution according to the present disclosure, the cast film manufactured by casting the polyamide solution of the present disclosure on a glass plate has a glass transition temperature (Tg) of 365° C. or higher, 370° C. or higher, or 380° C. or higher. In one or a plurality of embodiments, regarding the polyamide solution according to the present disclosure, the cast film manufactured by casting the polyamide solution of the present disclosure on a glass plate has a glass transition temperature (Tg) of lower than 365° C., 360° C. or lower, or 350° C. or lower. In one or a plurality of embodiments, the glass transition temperature (Tg) can be measured by the method as described in Examples.

[Coefficient of Thermal Expansion (CTE)]

In one or a plurality of embodiments, regarding the polyamide solution according to the present disclosure, the cast film produced by casting the polyamide solution of the present disclosure on a glass plate has CTE of 10.0 ppm/° C. or more, 12.5 ppm/° C. or more, 15.0 ppm/° C. or more, 17.5 ppm/° C. or more, 20 ppm/° C. or more, 30 ppm/° C. or more, 45 ppm/° C. or more, 50 ppm/° C. or more, or, 53 ppm/° C. or more. In one or a plurality of embodiments, CTE can be measured by the method as described in Examples.

[Total Light Transmittance]

In one or a plurality of embodiments, regarding the polyamide solution according to the present disclosure, from the viewpoint of use in the step of manufacturing elements such as a display element, an optical element, an illumination element, a sensor element and the like, the total light transmittance of the cast film produced by casting on a glass plate in the D line (Sodium line) is 80% or more, 82% or more, or 84% or more.

[Retardation (Rth)]

In one or a plurality of embodiments, regarding the polyamide solution according to the present disclosure, a cast film produced by applying the solution onto a glass plate has retardation (Rth) at a wavelength of 400 nm in the thickness direction of 100 nm or less, 90 nm or less, 80 nm or less, or 70 nm or less. In one or a plurality of embodiments, regarding the polyamide solution according to the present disclosure, a cast film produced by applying the solution onto a glass plate has retardation (Rth) at a wavelength of 550 nm in the film thickness direction of 90 nm or less, 80 nm or less, 70 nm or less, or 60 nm or less. Lower Rth is advantageous in suppressing degradation in the viewing angle in a liquid crystal display. Rth of the polyamide film is calculated using a retardation measurement device, and more specifically, it is measured by a method described in Examples.

[Amount of Curvature]

In the present disclosure, “amount of curvature” indicates the amount of warpage deformation of a laminated composite material produced by laminating a polyamide resin formed by casting on a glass plate a polyamide solution according to the present disclosure. In one or a plurality of embodiments, the amount of curvature refers to a difference between the maximal value and a minimal value of height of the laminated composite material measured with a laser displacement sensor. In one or a plurality of embodiments, the amount of curvature is measured by the method as described in Examples. When the value of the amount of curvature is positive, it means that the laminated composite material is the higher at the periphery than at the center; when the value of the amount of curvature is negative, it means that the laminated composite material is the lower at the periphery than at the center.

In one or a plurality of embodiments, regarding the polyamide solution according to the present disclosure, the amount of curvature of the laminated composite material measured with the displacement sensor is −500 μM or more and 500 μm or less, −300 μm or more and 300 μM or less, −200 μm or more and 200 μm or less, −150 μm or more and 50 μm or less, −80 μm or more and 80 μm or less, or −75 μm or more and 75 μm or less.

[Monomer Diamine Capable of Reducing Dimension Change Gap]

In one or a plurality of embodiments, the aromatic polyamide contained in the polyamide solution according to the present disclosure can be synthesized by polymerization reaction between a diamine monomer and a diacid dichloride monomer. In one or a plurality of embodiments, the aromatic polyamide contained in the polyamide solution according to the present disclosure is synthesized by use of at least one kind of monomer diamine capable of reducing dimension change gap. In one or a plurality of embodiments, the “monomer diamine capable of reducing dimension change gap” is capable of setting the dimension change gap within the above-mentioned range. In one or a plurality of embodiments, the “monomer diamine capable of reducing dimension change gap” may be monomer diamine capable of reducing tan δ of β relaxation peak. In one or a plurality of embodiments, the “monomer diamine capable of reducing dimension change gap” may be monomer diamine capable of setting tan δ of β relaxation peak within the above-mentioned range. Therefore, regarding the polyamide solution according to the present disclosure, in one or a plurality of embodiments, at least one kind of the diamine monomers used for synthesis of the aromatic polyamide is the monomer diamine capable of reducing the dimension change gap. Regarding the polyamide solution according to the present disclosure, in one or a plurality of embodiments, “the monomer diamine capable of reducing dimension change gap” makes up more than 5.0 mol %, 7.0 mol % or more, 10.0 mol % or more, 15.0 mol % or more, 20 mol % or more, 30 mol % or more, 40 mol % or more, 45 mol % or more, or, 47 mol % or more of the whole monomers used for synthesizing the aromatic polyamide.

In one or a plurality of embodiments, the “monomer diamine capable of reducing dimension change gap” is diamine represented by the general formula (X) below:

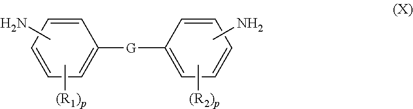

In the general formula 00, p=1 to 4, wherein R₁ and R₂ are independently selected from the group consisting of hydrogen, halogen (fluorine, chlorine, bromine, and iodine), alkyl, substituted alkyl such as halogenated alkyl, nitro, cyano, thioalkyl, alkoxy, substituted alkoxy such as halogenated alkoxy, aryl, substituted aryl such as halogenated aryl, alkyl ester, and substituted alkyl ester such as halogenated alkyl ester, and combinations thereof and where R₁ and R₂ are plural, each R₁ and/or R₂ can be same or different, and, wherein G is a organic group. It should be noted that in one or a plurality of embodiments, the organic groups do not comprise covalent bonds.

In one or a plurality of embodiments, G in the general formula (X) is selected from the group consisting of a SO₂ group; 9,9-fluorene group; substituted 9,9-fluorene group; and an OZO group, where Z is 9,9-bisphenylfluorene group or substituted 9,9-bisphenylfluorene group.

From the viewpoint of reducing the dimension change gap and suppressing warpage deformation, it is preferable that the “monomer diamine capable of reducing dimension change gap” is used more in the aromatic polyamide. In one or a plurality of embodiments, the total amount of the diamine monomer represented by the general formula (X) above with respect to the whole diamine monomer used for synthesis in the aromatic polyimide to be synthesized by polymerization reaction between the diamine monomer and the diacid dichloride monomer is more than 80 mol %, more preferably 85 mol % or more, further preferably 90 mol % or more, and even further preferably 95 mol % or more from the viewpoint of reducing the dimension change gap and suppressing warpage deformation.

Therefore, in one or a plurality of embodiments, from the viewpoint of reducing the dimension change gap and suppressing warpage deformation, the diamine monomer used for the synthesis of the aromatic polyamide may be a combination of the “monomer diamine capable of reducing dimension change gap” and “carboxyl group-containing diamine monomer” described below. In a case where the diamine monomer used for synthesis of the aromatic polyamide is a combination of “monomer diamine capable of reducing dimension change gap” and “carboxyl group-containing diamine monomer”, there is no necessity of including other diamine monomer. In a case where the other diamine monomer(s) is/are included, in one or a plurality of embodiments, from the viewpoint of reducing the dimension change gap and suppressing the warpage deformation, the content is less than 15 mol %, 10 mol % or less, 5 mol % or less, 1 mol % or less, or, 0.5 mol % or less with respect to the whole diamine monomer used for the synthesis.

In one or a plurality of embodiments, the “monomer diamine capable of reducing dimension change gap” may be at least one selected from the group consisting of FDA (9,9-bis(4-aminophenyl)fluorene), FFDA (9,9-bis(3-fluoro-4-aminophenyl)fluorene) and DDS (diaminodiphenyl sulfone). The DDS may be 4,4′-type, 3,3′-type, or 2,2′-type.

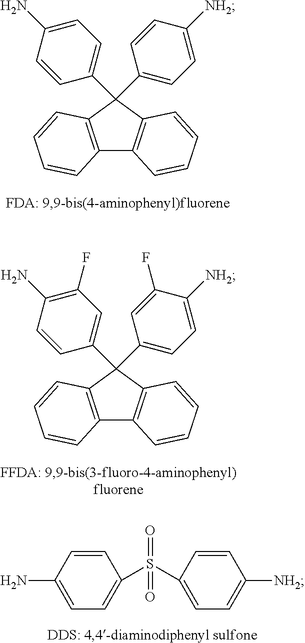 [SMILES: Nc1ccc(C2(c3ccc(N)cc3)c3ccccc3-c3ccccc32)cc1 ; Nc1ccc(C2(c3ccc(N)c(F)c3)c3ccccc3-c3ccccc32)cc1F ; Nc1ccc(S(=O)(=O)c2ccc(N)cc2)cc1]

Therefore, in a case where the “monomer diamine capable of reducing dimension change gap” is at least one selected from the group consisting of FDA, FFDA and DDS, the total amount of the FDA, FFDA and DDS with respect to the whole diamine monomer used for synthesis of the aromatic polyamide is preferably more than 80 mol %, more preferably 85 mol %, further preferably 90 mol %, and even further preferably 95 mol %, from the viewpoint of reducing dimension change gap and suppressing warpage deformation in one or a plurality of embodiments.

In one or a plurality of embodiments, the DDS and FFDA can suppress Rth (at wavelengths of 400 nm and 550 nm) more in comparison with FDA. In one or a plurality of embodiments, the DDS and FFDA can improve the light transmittance at 365 nm more in comparison with FDA. In one or a plurality of embodiments, DDS and FFDA have glass transition temperature lower than that of FDA. Although the mechanism has not been clarified, it is supposed that the FDA molecules in the polyamide are molecular-oriented more easily in comparison with DDS and FFDA.

From the viewpoint of reducing the dimension change gap and suppressing warpage deformation, DDS is used more preferably for the “monomer diamine capable of reducing dimension change gap”. Therefore, the amount of DDS with respect to the whole diamine monomer used for synthesis of the aromatic polyamide is preferably 30 mol % or more, more preferably 40 mol % or more, further preferably 45 mol % or more, even further preferably 50 mol % or more, even further preferably 60 mol % or more, and even further preferably 65 mol % or more. From the similar viewpoint, it is preferable that among two or more diamine monomers used for the synthesis, the amount of DDS (mol %) is the highest.

In one or a plurality of embodiments, the aromatic polyamide in the polyamide solution according to the present disclosure may be an aromatic polyamide having repeat units represented by the general formulae (I) and (II) below. In one or a plurality of embodiments, regarding the aromatic polyamide in the polyamide solution according to the present disclosure, the repeat units represented by the general formulae (I) and (II) below can include repetition derived from the “monomer diamine capable of reducing dimension change gap”. In one or a plurality of embodiments, the content of the repeat unit derived from the “monomer diamine capable of reducing dimension change gap” makes up more than 10.0 mol % and 14.0 mol % or more, 20.0 mol % or more, or 30.0 mol % or more of the whole repeat units. In one or a plurality of embodiments, the repeat unit derived from the “monomer diamine capable of reducing dimension change gap” makes up preferably 80 mol % or more, more preferably 85 mol % or more, further preferably 90 mol % or more, and even further preferably 95 mol % or more, from the viewpoint of reducing dimension change gap and suppressing warpage deformation.

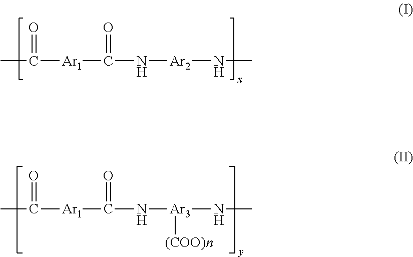

wherein x represents mol % of the constitutional unit (I), y represents mol % of the constitutional unit in the formula (II), x varies from 70 to 100 mol %, and y varies from 0 to 30 mol %, and wherein n=1 to 4. In the formulae (1) and (II), Ar₁ is selected from the group consisting of

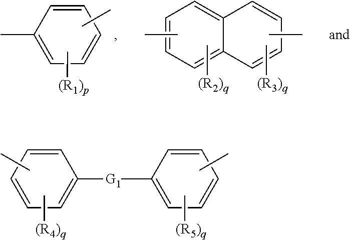

wherein p=4, q=3, and wherein R₁, R₂, R₃, R₄, R₅ are selected from the group consisting of hydrogen, halogen (fluorine, chlorine, bromine, and iodine), alkyl, substituted alkyl such as halogenated alkyl, nitro, cyano, thioalkyl, alkoxy, substituted alkoxy such as halogenated alkoxy, aryl, or substituted aryl such as halogenated aryl, alkyl ester and substituted alkyl ester such as halogenated alkyl ester, and combinations thereof. It is to be understood that each R₁ can be different, each R₂ can be different, each R₃ can be different, each R₄ can be different, and each R₅ can be different. G₁ is selected from the group consisting of a covalent bond; a CH₂ group; a C(CH₃)₂ group; a C(CF₃)₂ group; a C(CX₃)₂ group, where X is a halogen (fluoride, chloride, bromide, and iodide); a CO group; an O atom; a S atom; a SO₂ group; a Si (CH₃)₂ group; 9,9-fluorene group; substituted 9,9-fluorene group; and an OZO group, where Z is an aryl group or substituted aryl group, such as phenyl group, biphenyl group, perfluorobiphenyl group, 9,9-bisphenylfluorene group, and substituted 9, 9-bisphenylfluorene group;

In the formula (I), Ar₂ is selected from the group of comprising:

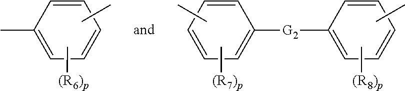

wherein p=4, wherein R₆, R₇, R₈ are selected from the group consisting of hydrogen, halogen (fluorine, chlorine, bromine, and iodine), alkyl, substituted alkyl such as halogenated alkyl, nitro, cyano, thioalkyl, alkoxy, substituted alkoxy such as halogenated alkoxy, aryl, substituted aryl such as halogenated aryl, alkyl ester, and substituted alkyl ester such as halogenated alkyl ester, and combinations thereof. It is to be understood that each R₆ can be different, each R₇ can be different, and each R₈ can be different. G₂ is selected from the group consisting of a covalent bond; a CH₂ group; a C(CH₃)₂ group; a C(CF₃)₂ group; a C(CX₃)₂ group, where X is a halogen; a CO group; an O atom; a S atom; a SO₂ group; a Si (CH₃)₂ group; 9,9-fluorene group; substituted 9,9-fluorene group; and an OZO group, where Z is an aryl group or substituted aryl group, such as phenyl group, biphenyl group, perfluorobiphenyl group, 9,9-bisphenylfluorene group, and substituted 9,9-bisphenylfluorene group;

In the formula (II), Ar₃ is selected from the group consisting of

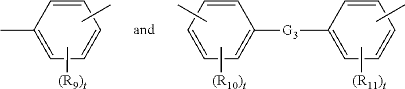

wherein t=0 to 3, wherein R₉, R₁₀, R₁₁ are selected from the group consisting of hydrogen, halogen (fluorine, chlorine, bromine, and iodine), alkyl, substituted alkyl such as halogenated alkyl, nitro, cyano, thioalkyl, alkoxy, substituted alkoxy such as halogenated alkoxy, aryl, substituted aryl such as halogenated aryl, alkyl ester, and substituted alkyl ester such as halogenated alkyl ester, and combinations thereof. It is to be understood that each R₉ can be different, each R₁₀ can be different, and each R₁₁ can be different. G₃ is selected from the group consisting of a covalent bond; a CH₂ group; a C(CH₃)₂ group; a C(CF₃)₂ group; a C(CX₃)₂ group, where X is a halogen; a CO group; an O atom; a S atom; a SO₂ group; a Si (CH₃)₂ group; 9,9-fluorene group; substituted 9,9-fluorene group; and an OZO group, where Z is an aryl group or substituted aryl group, such as phenyl group, biphenyl group, perfluorobiphenyl group, 9,9-bisphenylfluorene group, and substituted 9,9-bisphenylfluorene group.

In one or a plurality of embodiments of the present disclosure, (I) and (II) are selected so that the polyamide is soluble in a polar solvent or a mixed solvent comprising one or more polar solvents. In one or a plurality of embodiments of the present disclosure, x varies from 70.0 to 99.99 mol % of the repeat structure (I), and y varies from 30.0 to 0.01 mol % of the repeat structure (II). In one or a plurality of embodiments of the present disclosure, x varies from 90.0 to 99.9 mol % of the repeat structure (I), and y varies from 10.0 to 0.01 mol % of the repeat structure (II). In one or a plurality of embodiments of the present disclosure, x varies from 90.1 to 99.9 mol % of the repeat structure (I), and y varies from 9.9 to 0.1 mol % of the repeat structure (II). In one or a plurality of embodiments of the present disclosure, x varies from 91.0 to 99.0 mol % of the repeat structure (I), and y varies from 9.0 to 1.0 mol % of the repeat structure (II). In one or a plurality of embodiments of the present disclosure, x varies from 92.0 to 98.0 mol % of the repeat structure (I), and y varies from 8.0 to 2.0 mol % of the repeat structure (II). In one or a plurality of embodiments of the present disclosure, the aromatic polyamide contains multiple repeat units with the structures (I) and (II) where An, Are, and Ara are the same or different.

In one or a plurality of embodiments, from the viewpoint of using the film for a display element, an optical element, an illumination element or a sensor element, the polyamide solution according to the present disclosure is one obtained or obtainable by a manufacturing method including the following steps. However, the polyamide solution according to the present disclosure is not limited to one manufactured by the following method.
a) dissolving aromatic diamine in a solvent;
b) reacting the aromatic diamine with aromatic diacid dichloride, thereby generating hydrochloric acid and a polyamide solution;
c) removing the free hydrochloric acid by reaction with a trapping reagent.

In one or a plurality of embodiments of the method for manufacturing a polyamide solution of the present disclosure, the aromatic diacid dichloride is an aromatic dicarboxylic acid dichloride, and includes those shown in the following general structures:

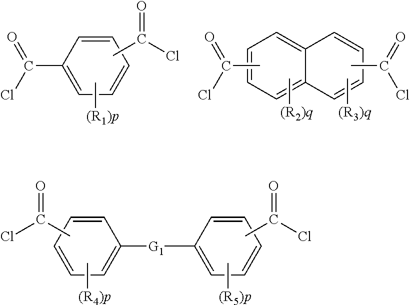

wherein p=4, q=3, and wherein R₁, R₂, R₃, R₄, R₅ are selected from the group consisting of hydrogen, halogen (fluorine, chlorine, bromine, and iodine), alkyl, substituted alkyl such as halogenated alkyl, nitro, cyano, thioalkyl, alkoxy, substituted alkoxy such as a halogenated alkoxy, aryl, or substituted aryl such as halogenated aryl, alkyl ester and substituted alkyl ester such as halogenated alkyl ester, and combinations thereof. It is to be understood that each R₁ can be different, each R₂ can be different, each R₃ can be different, each R₄ can be different, and each R₅ can be different. G₁ is selected from the group consisting of a covalent bond; a CH₂ group; a C(CH₃)₂ group; a C(CF₃)₂ group; a C(CX₃)₂ group, where X is a halogen; a CO group; an O atom; a S atom; a SO₂ group; a Si (CH₃)₂ group; 9,9-fluorene group; substituted 9,9-fluorene group; and an OZO group, where Z is an aryl group or substituted aryl group, such as phenyl group, biphenyl group, perfluorobiphenyl group, 9,9-bisphenylfluorene group, and substituted 9,9-bisphenylfluorene group.

In one or a plurality of embodiments, from the viewpoint of using the film in a display element, an optical element, an illumination element or a sensor element, examples of the aromatic diacid dichloride used in the method for manufacturing the polyimide solution according the present disclosure include the following.

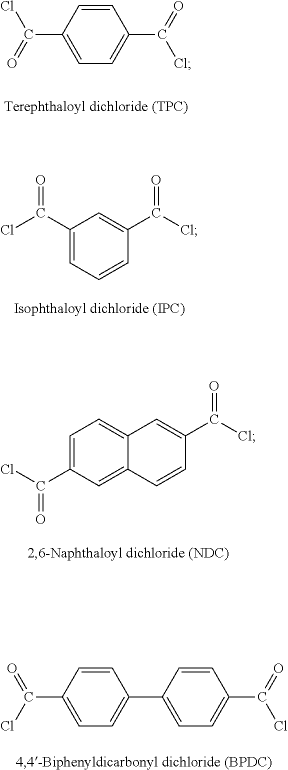 [SMILES: O=C(Cl)c1ccc(C(=O)Cl)cc1 ; O=C(Cl)c1cccc(C(=O)Cl)c1 ; O=C(Cl)c1ccc2cc(C(=O)Cl)ccc2c1 ; O=C(Cl)c1ccc(-c2ccc(C(=O)Cl)cc2)cc1]

In one or a plurality of embodiments of the method for manufacturing a polyamide solution of the present disclosure, the aromatic diacid diamine includes those shown in the following general structures:

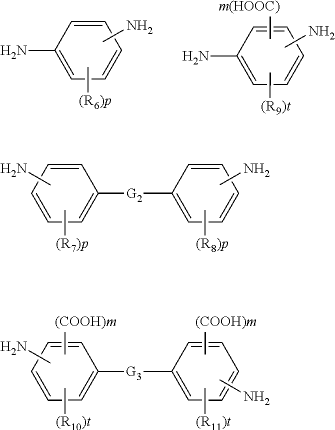

wherein p=4, m=1 or 2, and t=1 to 3, wherein R₆, R₇, R₈, R₉, R₁₀, R₁₁ are selected from the group consisting of hydrogen, halogen (fluorine, chlorine, bromine, and iodine), alkyl, substituted alkyl such as halogenated alkyl, nitro, cyano, thioalkyl, alkoxy, substituted alkoxy such as a halogenated alkoxy, aryl, substituted aryl such as halogenated aryl, alkyl ester, and substituted alkyl ester such as halogenated alkyl ester, and combinations thereof. It is to be understood that each R₆ can be different, each R₇ can be different, each R₈ can be different, each R₉ can be different, each R₁₀ can be different, and each R₁₁ can be different. G₂ and G₃ are selected from the group consisting of a covalent bond; a CH₂ group; a C(CH₃)₂ group; a C(CF₃)₂ group; a C(CX₃)₂ group, where X is a halogen; a CO group; an O atom; a S atom; a SO₂ group; a Si (CH₃)₂ group; 9,9-fluorene group; substituted 9,9-fluorene group; and an OZO group, where Z is an aryl group or substituted aryl group, such as phenyl group, biphenyl group, perfluorobiphenyl group, 9,9-bisphenylfluorene group, and substituted 9,9-bisphenylfluorene group.

In one or a plurality of embodiments, in addition to the above-mentioned “monomer diamine capable of reducing dimension change gap”, an aromatic diamine used in the method for manufacturing a polyamide solution according the present disclosure include the following;

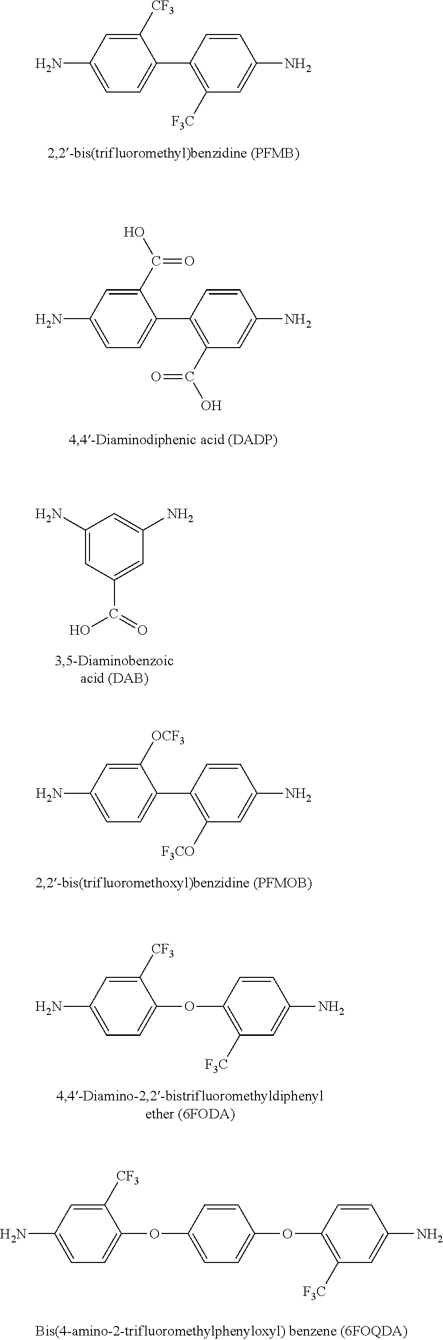 [SMILES: Nc1ccc(-c2ccc(N)cc2C(F)(F)F)c(C(F)(F)F)c1 ; Nc1ccc(-c2ccc(N)cc2C(=O)O)c(C(=O)O)c1 ; Nc1cc(N)cc(C(=O)O)c1 ; Nc1ccc(-c2ccc(N)cc2OC(F)(F)F)c(OC(F)(F)F)c1 ; Nc1ccc(Oc2ccc(N)cc2C(F)(F)F)c(C(F)(F)F)c1 ; Nc1ccc(Oc2ccc(Oc3ccc(N)cc3C(F)(F)F)cc2)c(C(F)(F)F)c1]

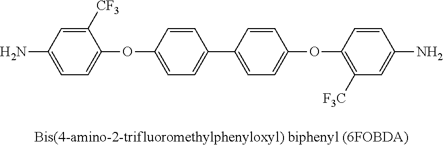 [SMILES: Nc1ccc(Oc2ccc(-c3ccc(Oc4ccc(N)cc4C(F)(F)F)cc3)cc2)c(C(F)(F)F)c1]

In one or a plurality of embodiments of the method for manufacturing a polyamide solution of the present disclosure, a polyamide is produced via a condensation polymerization in a solvent, where the hydrochloric acid generated in the reaction is trapped by a reagent like propylene oxide (PrO).

In one or a plurality of embodiments of the present disclosure, from the viewpoint of use of the polyamide solution in the method for manufacturing a display element, an optical element, an illumination element or a sensor element, the reaction of hydrochloric acid with the trapping reagent yields a volatile product.

In one or a plurality of embodiments of the present disclosure, from the viewpoint of use of the polyamide solution in the method for manufacturing a display element, an optical element, an illumination element or a sensor element, the trapping reagent is propylene oxide (PrO). In one or a plurality of embodiments of the present disclosure, the reagent is added to the mixture before or during the reacting step (b). Adding the reagent before or during the reaction step (b) can reduce degree of viscosity and generation of lumps in the mixture after the reaction step (b), and therefore, can improve productivity of the polyamide solution. These effects are significant specifically when the reagent is organic reagent, such as propylene oxide.

In one or a plurality of embodiments of the present disclosure, from the viewpoint of enhancement of heat resistance property of the polyamide film, the method further comprises the step of end-capping of one or both of terminal —COOH group and terminal —NH₂ group of the polyamide. The terminal of the polyamide can be end-capped by the reaction of polymerized polyamide with benzoyl chloride when the terminal of polyamide is —NH₂, or reaction of polymerized polyamide with aniline when the terminal of polyamide is —COOH. However, the method of end-capping is not limited to this method.

In one or a plurality of embodiments of the present disclosure, from the viewpoint of use of the polyamide solution in the method for manufacturing a display element, an optical element, an illumination element or a sensor element, the polyamide is first isolated from the polyamide solution by re-dissolution (hereinafter, referred also as re-precipitation). The re-precipitation can be carried out by a typical method. In one or a plurality of embodiments, by adding the polyamide to methanol, ethanol, isopropyl alcohol or the like, it is precipitated, cleaned, and dissolved in the solvent, for example.

In one or a plurality of embodiments of the present disclosure, from the viewpoint of use of the polyamide solution in the method for manufacturing a display element, an optical element, an illumination element or a sensor element, the polyamide solution is produced in the absence of inorganic salt.

[Average Molecular Weight of Polyamide]

In one or a plurality of embodiments, from the viewpoint of using the film in a display element, an optical element, an illumination element or a sensor element and suppressing whitening, it is preferable that the aromatic polyamide of the polyamide solution according to the present disclosure has a number-average molecular weight (Mn) of 6.0×10⁴ or more, 6.5×10⁴ or more, 7.0×10⁴ or more, 7.5×10⁴ or more, or 8.0×10⁴ or more. From a similar viewpoint, in one or a plurality of embodiments, the number-average molecular weight is 1.0×10⁶ or less, 8.0×10⁵ or less, 6.0×10⁵ or less, or 4.0×10⁵ or less.

In the present disclosure, the number-average molecular weight (Mn) and the weight-average molecular weight (Mw) of the polyamide are measured by Gel Permeation Chromatography, and more specifically, they are measured by a method described in Examples.

In one or a plurality of embodiments, from the viewpoint of using the film in a display element, an optical element, an illumination element or a sensor element and suppressing whitening, it is preferable that the molecular weight distribution (=Mw/Mn) of the aromatic polyamide of the polyamide solution according to the present disclosure is 5.0 or less, 4.0 or less, 3.0 or less, 2.8 or less, 2.6 or less, or 2.4 or less. From a similar viewpoint, in one or a plurality of embodiments, the molecular weight distribution of the aromatic polyamide is 2.0 or more.

In one or a plurality of embodiments, from the viewpoint of using the film in a display element, an optical element, an illumination element or a sensor element, the polyamide solution according to the present disclosure is one undergone re-precipitation after the synthesis of the polyamide.

Regarding the polyamide solution according to the present disclosure, in one or a plurality of embodiments, from the viewpoint of using the film in a display element, an optical element, an illumination element or a sensor element, the monomer used for synthesis of polyamide may include a carboxyl group-containing diamine monomer. In such a case, in one or a plurality of embodiments, the content of the carboxyl group-containing diamine monomer ingredient with respect to the total amount of the monomer may be 30 mol % or less, 20 mol % or less, or, 1 to 10 mol %.

[Solvent]

In one or a plurality of embodiments of the present disclosure, from the viewpoint of enhancement of solubility of the polyamide to the solvent, the solvent is a polar solvent or a mixed solvent comprising one or more polar solvents. In one embodiment of the present disclosure, from the viewpoint of enhancement of solubility of the polyamide to the solvent, the polar solvent is methanol, ethanol, propanol, isopropanol (IPA), butanol, acetone, methyl ethyl ketone (MEK), methyl isobutyl ketone (MIBK), toluene, cresol, xylene, propyleneglycol monomethyl ether acetate (PGMEA), N,N-dimethylacetamide (DMAc), N-methyl-2-pyrrolidone (NMP), dimethylsulfoxide (DMSO), butyl cellosolve, γ-butyrolactone, α-methyl-γ-butyrolactone, methyl cellosolve, ethyl cellosolve, ethylene glycol monobutyl ether, diethylene glycol monobutyl ether, N,N-dimethylformamide (DMF), 3-methoxy-N,N-dimethylpropionamide, 3-butoxy-N,N-dimethylpropanamide, 1-ethyl-2-pyrrolidone, N,N-dimethylpropionamide, N,N-dimethylbutyramide, N,N-diethylacetamide, N,N-diethylpropionamide, 1-methyl-2-piperidinone, propylene carbonate, a combination thereof, or a mixed solvent comprising at least one of the solvents.

[Content of Polyamide]

In one or a plurality of embodiments, the content of the aromatic polyamide in the polyamide solution according to the present disclosure may be 2% by weight or more, 3% by weight or more, or, 5% by weight or more from the viewpoint of use of the film for a display element, an optical element, an illumination element or a sensor element. From a similar viewpoint, it may be 30% by weight or less, 20% by weight or less, or, 15% by weight or less.

[Multifunctional Epoxide]

In one or a plurality of embodiments, from the viewpoint of lowering the curing temperature at the time formation of the cast film and improving the resistance of the film to an organic solvent, the polyamide solution according to the present disclosure may contain further a multifunctional epoxide. In the present disclosure, a “multifunctional epoxide” refers to an epoxide having two or more epoxy groups. In a case where the polyamide solution according to the present disclosure contains the multifunctional epoxide, in one or a plurality of embodiments, the content of the multifunctional epoxide may be about 0.1 to 10% by weight with respect to the weight of polyamide.

In one or a plurality of embodiments, it is possible to lower the curing temperature for the polyamide solution according to the present disclosure containing the multifunctional epoxide. In one or a plurality of non-limiting embodiments, the curing temperature of the film can be set to the range of about 200° C. to about 300° C. Further, in one or a plurality of embodiments, the polyamide solution according to the present disclosure containing a multifunctional epoxide can provide the film formed from the polyamide solution with resistance to an organic solvent. Examples of the organic solvent include polar solvents such as N-methyl-2-pyrrolidone (NMP), N,N-dimethylacetamide (DMAc), dimethylsulfoxide (DMSO), and γ-butyrolactone.

It is supposed that the effects of lowering the curing temperature and improving the resistance to the organic solvent in the polyamide solution according to the present disclosure containing a multifunctional epoxide are provided by crosslinking caused by the epoxide. From the viewpoint of promoting the crosslinking caused by the epoxide, in one or a plurality of embodiments, it is preferable that the polyamide in the polyamide solution according to the present disclosure containing the multifunctional epoxide has a free pendant carboxy group in its principal chain, or it is synthesized by using a diamine monomer having a carboxy group.

From the viewpoint of lowering the curing temperature and improving the resistance to the organic solvent, in one or a plurality of embodiments, examples of the multifunctional epoxide may include an epoxide having two or more glycidyl groups; or an epoxide having two or more alicyclic structures. Further, the multifunctional epoxide may be selected from the group consisting of the ones represented by general formulae (I) to (IV).

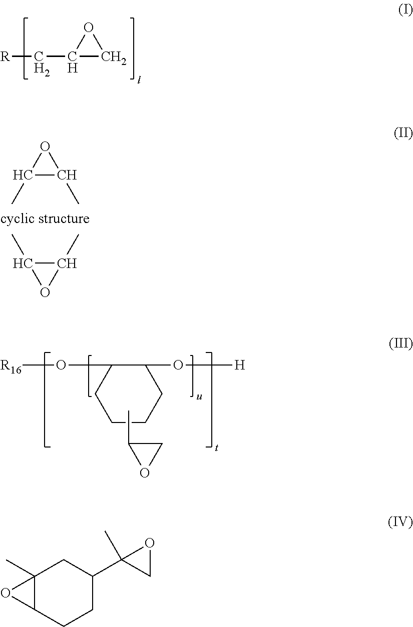

In the formula (I), l represents the number of glycidyl groups, wherein R is selected from the group consisting of

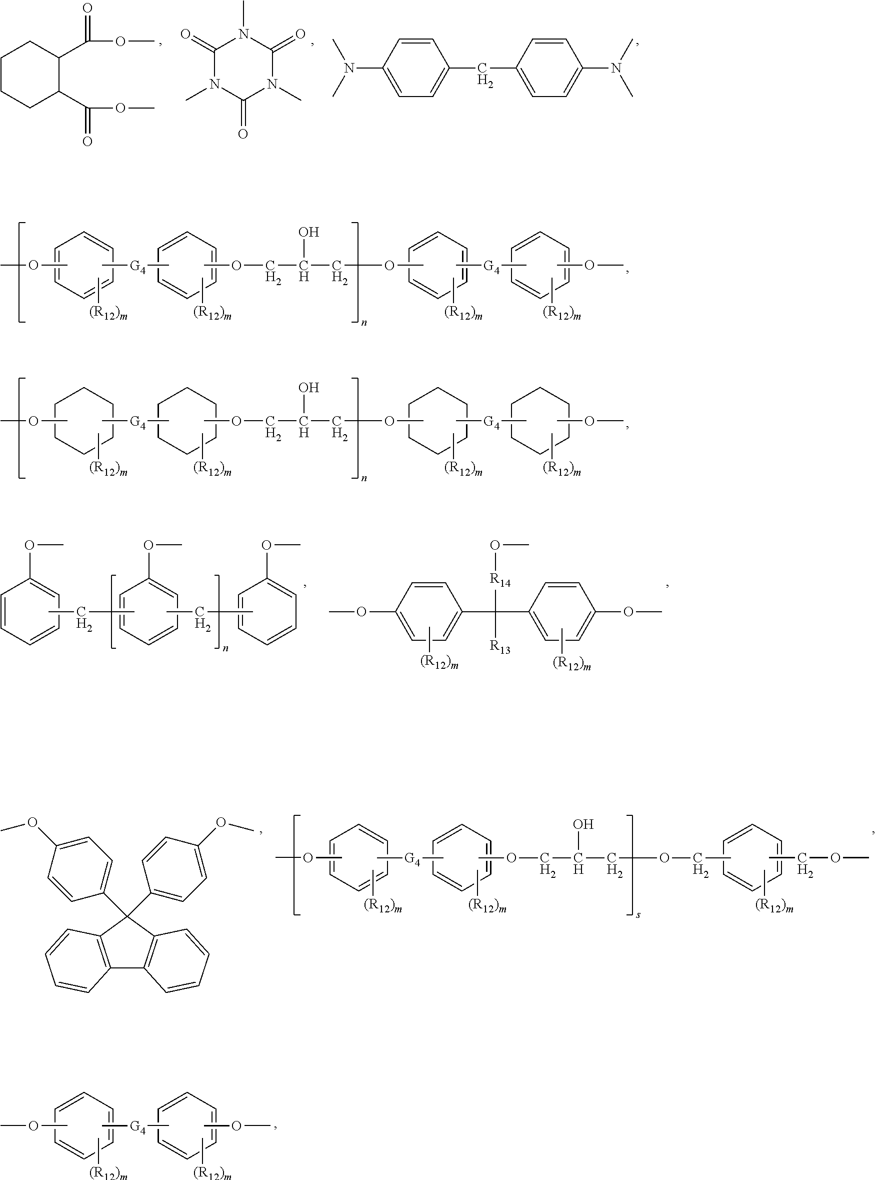

and a combination thereof, wherein m is 1 to 4, wherein n and s represent the average unit numbers, each of which is in the range of 0 to 30 independently, wherein R₁₂ is selected from the group consisting of hydrogen, halogen (fluorine, chlorine, bromine, and iodine), alkyl, substituted alkyl such as halogenated alkyl, nitro, cyano, thioalkyl, alkoxy, substituted alkoxy such as halogenated alkoxy, aryl, or substituted aryl such as halogenated aryl, alkyl ester and substituted alkyl ester such as halogenated alkyl ester, and a combination thereof. G₄ is selected from the group consisting of a covalent bond; a CH₂ group; a C(CH₃)₂ group; a C(CF₃)₂ group; a C(CX₃)₂ group, where X is a halogen; a CO group; an O atom; a S atom; a SO₂ group; a Si (CH₃)₂ group; 9,9-fluorene group; substituted 9,9-fluorene group; and an OZO group, where Z is an aryl group or substituted aryl group, such as phenyl group, biphenyl group, perfluorobiphenyl group, 9,9-bisphenylfluorene group, and substituted 9,9-bisphenylfluorene group. R₁₃ is either hydrogen or a methyl group; and R₁₄ is a divalent organic group.

In the formula (II), a cyclic structure is selected from the group consisting of

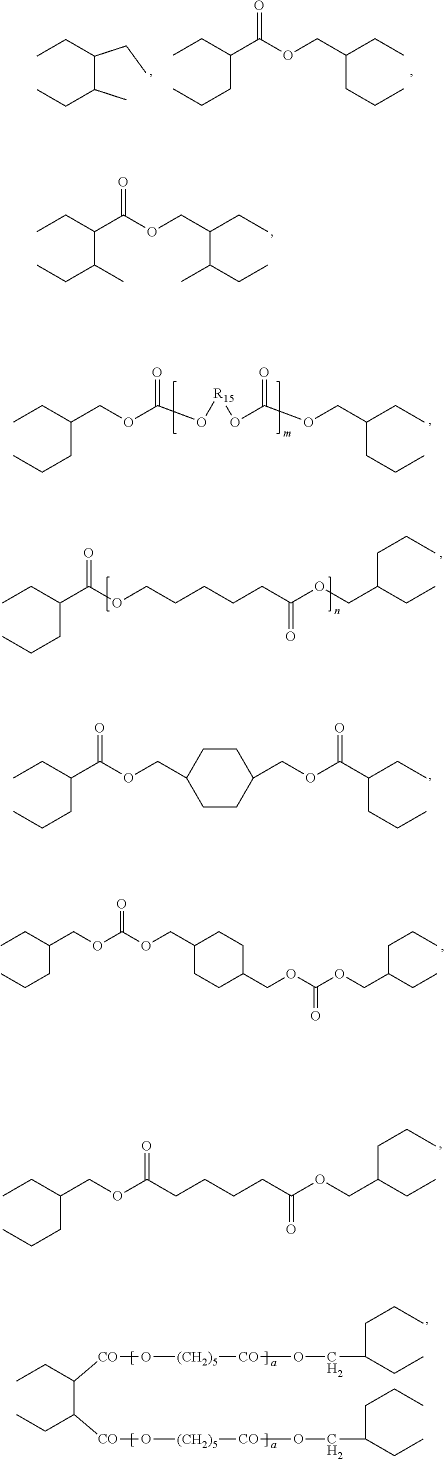

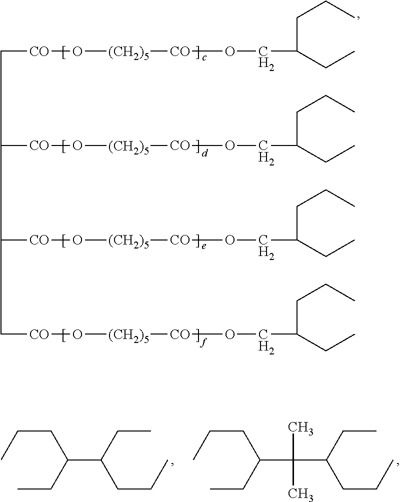

and a combination thereof, wherein R₁₅ is a C2-C18 alkyl chain, which may be a linear chain, a branched chain, or a chain including a cycloalkane structure, wherein m and n are the average unit numbers, each of which is in the range of 1 to 30 independently, and wherein each of a, b, c, d, e and f is the number in the range of 0 to 30 independently.

In the formula (III), R₁₆ is a C2-C18 alkyl chain, which may be a linear chain, a branched chain, or a chain including cycloalkane and wherein t and u are the average unit numbers, each of which is in the range of 0 to 30 independently.

Examples of multifunctional epoxide to be contained in the polyamide solution according to the present disclosure may be:

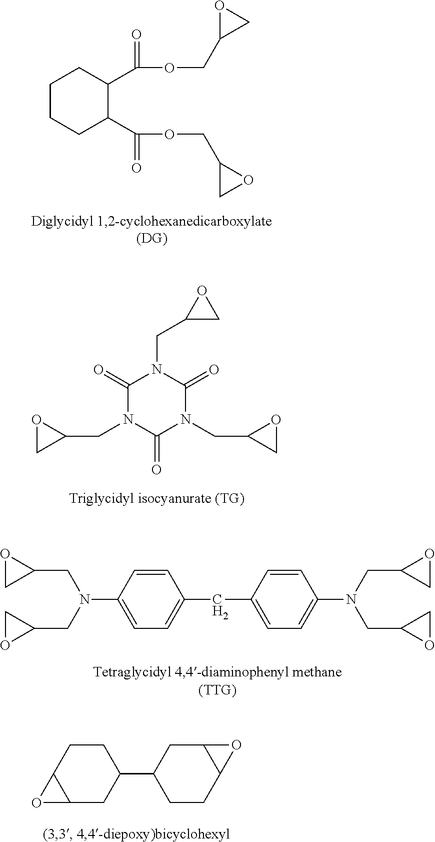 [SMILES: O=C(OCC1CO1)C1CCCCC1C(=O)OCC1CO1 ; O=c1n(CC2CO2)c(=O)n(CC2CO2)c(=O)n1CC1CO1 ; c1cc(N(CC2CO2)CC2CO2)ccc1Cc1ccc(N(CC2CO2)CC2CO2)cc1 ; C1CC2OC2CC1C1CCC2OC2C1]

and furthermore, include as follows.

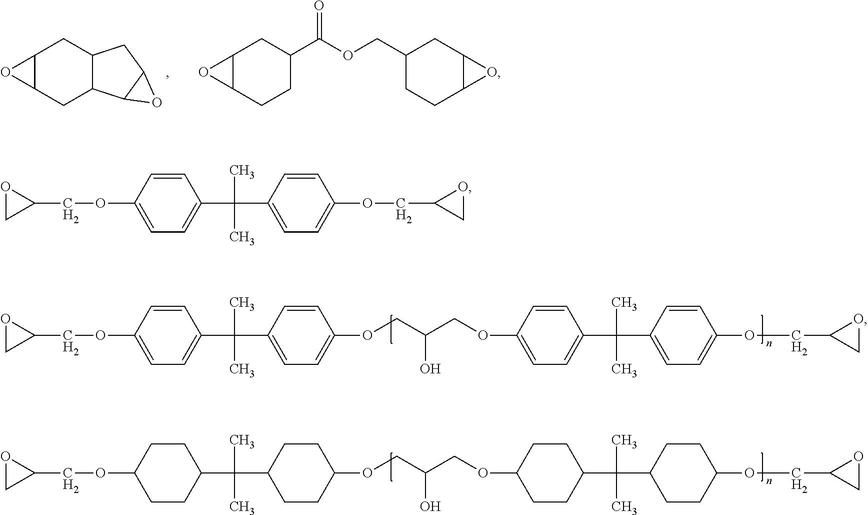

In one or a plurality of embodiments, the polyamide solution according to the present disclosure is a polyamide solution for use in a method for manufacturing a display element, an optical element, an illumination element or a sensor element, including the steps a) to c).

a) applying a solution of an aromatic polyamide onto a base;

b) forming a polyamide film on the base after the applying step (a); and

c) forming the display element, the optical element or the illumination element, or the sensor element, on the surface of polyamide film.

Here, the base or the surface of the base is composed of glass or silicon wafer. Further, in one or a plurality of embodiments, for the application in the step a), various methods for liquid phase film formation such as dye-coating, ink-jetting, spin-coating, bar-coating, roll-coating, wire bar coating, and dip-coating can be used.

[Laminated Composite Material]

The term “laminated composite material” as used herein refers to a material in which a glass plate and a polyamide resin layer are laminated. In one or a plurality of non-limiting embodiments, a glass plate and a polyamide resin layer being laminated indicates that the glass plate and the polyamide resin layer are laminated directly. Alternatively, in one or a plurality of non-limiting embodiments, it indicates that the glass plate and the polyamide resin layer are laminated via one or a plurality of layers. In the present disclosure, the organic resin of the organic resin layer is a polyamide resin. Therefore in one or a plurality of embodiments, the laminated composite material in the present disclosure includes a glass plate and a polyamide resin layer, i.e., a polyamide resin layer laminated on one surface of a glass plate.

In one or a plurality of non-limiting embodiments, the laminated composite material according to the present disclosure can be used in a method for manufacturing a display element, an optical element, an illumination element or a sensor element, such as the one illustrated in FIG. 1. Further, in one or a plurality of non-limiting embodiments, the laminated composite material according to the present disclosure can be used as a laminated composite material obtained in the step B of the manufacturing method illustrated in FIG. 2. Therefore, in one or a plurality of non-limiting embodiments, the laminated composite material according to the present disclosure is a laminated composite material to be used for a method for manufacturing a display element, an optical element, an illumination element or a sensor element, the method including forming a display element, an optical element or an illumination element, or a sensor element on a surface of the polyamide resin layer which is opposite to the surface facing the glass plate.

The laminated composite material according to the present disclosure may include additional organic resin layers and/or inorganic layers in addition to the polyamide resin layer. In one or a plurality of non-limiting embodiments, examples of additional organic resin layers include a flattened coat layer.

Further, in one or a plurality of non-limiting embodiments, examples of inorganic layers include a gas barrier layer capable of suppressing permeation of water or oxygen and a buffer coat layer capable of suppressing migration of ions to a TFT element.

FIG. 2 shows one or a plurality of non-limiting embodiments where an inorganic layer is formed between the glass plate and the polyamide resin layer. An example of the inorganic layer in this embodiment is an amorphous Si layer formed on the glass plate. In the step A, polyamide vanish is applied onto the amorphous Si layer on the glass plate, which is dried and/or cured in the step B thereby a laminated composite material is formed. In the step C, a display element, an optical element or an illumination element, or a sensor element is/are formed on the polyamide resin layer (polyamide film) of the laminated composite material, and in the step D, the amorphous Si layer is irradiated with a laser, thereby the display element, the optical element, the illumination element or the sensor element as the product (including the polyamide resin layer) is de-bonded from the glass plate.

FIG. 3 shows one or a plurality of non-limiting embodiments where an inorganic layer is formed on the surface of a polyamide resin layer which is opposite to the surface facing the glass plate. An example of the inorganic layer in this embodiment is an inorganic barrier layer. In the step A, a polyamide vanish is applied onto a glass plate, which is dried and/or cured in the step B thereby forming a laminated composite material. At this time, a further inorganic layer is formed on the polyamide resin layer (polyimide film). In one or a plurality of non-limiting embodiments, the laminated composite material in the present disclosure may include the inorganic layer (FIG. 3, step C). On this inorganic layer, a display element, an optical element or an illumination element, or a sensor element is/are formed. In the step D, the polyamide resin layer is de-bonded so as to obtain a display element, an optical element, an illumination element or a sensor element as the product (including polyamide resin layer).

[Polyamide Resin Layer]

The polyimide resin of the polyamide resin layer of the laminated composite material according to the present disclosure can be formed using the polyamide solution according to the present disclosure.

[Thickness of Polyamide Resin Layer]

In one or a plurality of embodiments, from the viewpoint of using the film in a display element, an optical element, an illumination element or a sensor element and suppressing the development of cracks in the resin layer, the polyamide resin layer of the laminated composite material according to the present disclosure has a thickness of 500 μm or less, 200 μm or less, or 100 μm or less. Further, in one or a plurality of non-limiting embodiments, the polyamide resin layer has a thickness of 1 μm or more, 2 μm or more, or 3 μm or more, for example.

[Transmittance of Polyamide Resin Layer]

In one or a plurality of embodiments, the polyamide resin layer of the laminated composite material according to the present disclosure has a total light transmittance of 70% or more, 75% or more, or 80% or more from the viewpoint of allowing the laminated composite material to be used suitably in manufacturing a display element, an optical element, an illumination element or a sensor element.

[Glass Plate]

In one or a plurality of embodiments, from the viewpoint of using the film in a display element, an optical element, an illumination element or a sensor element, the material of the glass plate of the laminated composite material according to the present disclosure may be, for example, soda-lime glass, none-alkali glass or the like.

In one or a plurality of embodiments, from the viewpoint of using the film in a display element, an optical element, an illumination element or a sensor element, the glass plate of the laminated composite material according the present disclosure has a thickness of 0.3 mm or more, 0.4 mm or more, or 0.5 mm or more. Further, in one or a plurality of embodiments, the glass plate has a thickness of 3 mm or less or 1 mm or less, for example.

[Method for Manufacturing Laminated Composite Material]

The laminated composite material according to the present disclosure can be manufactured by applying the polyamide solution according to the present disclosure onto a glass plate, and drying, and if necessary curing, the applied solution.

In one or a plurality of embodiments of the present disclosure, a method for manufacturing the laminated composite material of the present disclosure includes the steps of

a) applying a solution of an aromatic polyamide onto a base (glass plate); and

b) heating the casted polyamide solution to form a polyamide film after the applying step (a).

In one or a plurality of embodiments of the present disclosure, from the viewpoint of suppression of curvature deformation (warpage) and/or enhancement of dimension stability, the heating is carried out under the temperature ranging from approximately +40° C. of the boiling point of the solvent to approximately +100° C. of the boiling point of the solvent, preferably from approximately +60° C. of the boiling point of the solvent to approximately +80° C. of the boiling point of the solvent, more preferably approximately +70° C. of the boiling point of the solvent. In one or a plurality of embodiments of the present disclosure, from the viewpoint of suppression of curvature deformation (warpage) and/or enhancement of dimension stability, the temperature of the heating in step (b) is between approximately 200° C. and approximately 250° C. In one or a plurality of embodiments of the present disclosure, from the viewpoint of suppression of curvature deformation (warpage) and/or enhancement of dimension stability, the time of the heating is more than approximately 1 minute and less than approximately 30 minutes.

The method for manufacturing the laminated composite material may include, following the step (b), a curing step (c) in which the polyamide film is cured. The curing temperature depends upon the capability of a heating device but is 220 to 420° C., 280 to 400° C., 330° C. to 370° C., 340° C. or more or 340 to 370° C. in one or a plurality of embodiments. Further, in one or a plurality of embodiments, the curing time is 5 to 300 minutes or 30 to 240 minutes.

[Method for manufacturing Display Element, Optical Element or Illumination Element]

The present disclosure, in one aspect, relates to a method for manufacturing a display element, an optical element, or an illumination element, which includes the step of forming the display element, the optical element, or the illumination element on a surface of the organic resin layer of the laminated composite material according to the present disclosure, i.e., a surface opposite to the surface facing the glass plate. In one or a plurality of embodiments, the manufacturing method further includes the step of de-bonding the thus formed display element, the optical element, or the illumination element formed from the glass plate.

[Display Element, Optical Element, or Illumination Element]

The term “a display element, an optical element, or an illumination element” as used in the present disclosure refers to an element that constitutes a display (display device), an optical device, or an illumination device, and examples of such elements include an organic EL element, a liquid crystal element, and organic EL illumination. Further, the term also covers a component of such elements, such as a thin film transistor (TFT) element, a color filter element or the like. In one or a plurality of embodiments, the display element, the optical element or the illumination element according to the present disclosure may include a product manufactured by using the polyamide solution according to the present disclosure, and a product using a polyamide film according to this disclosure as a substrate for the display element, the optical element or the illumination element.

<Non-Limiting Embodiment of Organic EL Element>

Hereinafter, one embodiment of an organic EL element as one embodiment of the display element according to the present disclosure will be described with reference to the drawing.

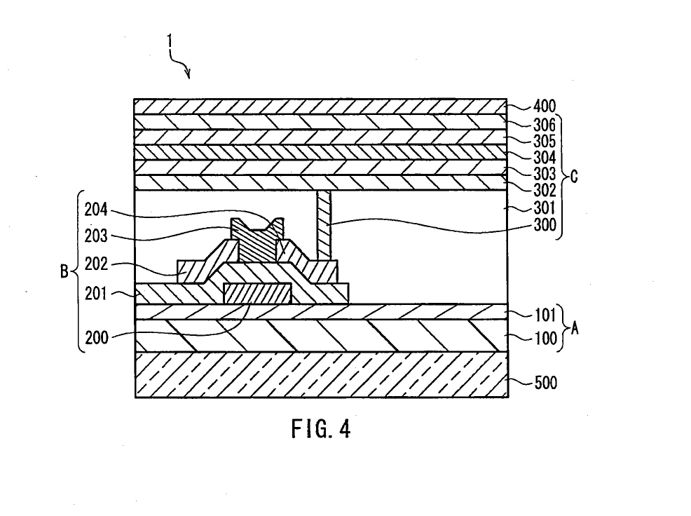

FIG. 4 is a schematic cross-sectional view showing an organic EL element 1 according to one embodiment. The organic EL element 1 includes a thin film transistor B formed on a substrate A and an organic EL layer C. Note that the organic EL element 1 is entirely covered with a sealing member 400. The organic EL element 1 may be separated from a base 500 or may include the base 500. Hereinafter, each component will be described in detail.

1. Substrate A

The substrate A includes a transparent resin substrate 100 and a gas barrier layer 101 formed on top of the transparent resin substrate 100. Here, the transparent resin substrate 100 is the polyimide film according to the present disclosure.

The transparent resin substrate 100 may have been annealed by heat. Annealing is effective in, for example, removing distortions and in improving the size stability against environmental changes.

The gas barrier layer 101 is a thin film made of SiOx, SiNx or the like, and is formed by a vacuum deposition method such as sputtering, CVD, vacuum deposition or the like. Generally, the gas barrier layer 101 has a thickness of, but is not limited to, about 10 nm to 100 nm. Here, the gas barrier layer 101 may be formed on the side of the transparent resin substrate 100 facing the gas barrier layer 101 in FIG. 1 or may be formed on the both sides.

2. Thin Film Transistor

The thin film transistor B includes a gate electrode 200, a gate insulating film 201, a source electrode 202, an active layer 203, and a drain electrode 204. The thin film transistor B is formed on the gas barrier layer 101.

The gate electrode 200, the source electrode 202, and the drain electrode 204 are transparent thin films made of indium tin oxide (ITO), indium zinc oxide (IZO), zinc oxide (ZnO), or the like. For example, sputtering, vapor deposition, ion plating or the like may be use to form these transparent thin films. Generally, these electrodes have a film thickness of, but are not limited to, about 50 nm to 200 nm.

The gate insulating film 201 is a transparent insulating thin film made of SiO₂, Al₂O₃ or the like, and is formed by sputtering, CVD, vacuum deposition, ion plating or the like. Generally, the gate insulating film 201 has a film thickness of, but is not limited to, about 10 nm to 1 μm.

The active layer 203 is a layer of, for example, single crystal silicon, low temperature polysilicon, amorphous silicon, or oxide semiconductor, and a material best suited to the active layer 203 is used as appropriate. The active layer is formed by sputtering or the like.

3. Organic EL layer

The organic EL layer C includes a conductive connector 300, an insulative flattened layer 301, a lower electrode 302 as the anode of the organic EL element 1, a hole transport layer 303, a light-emitting layer 304, an electron transport layer 305, and an upper electrode 306 as the cathode of the organic EL element 1. The organic EL layer C is formed at least on the gas barrier layer 101 or on the thin film transistor B, and the lower electrode 302 and the drain electrode 204 of the thin film transistor B are connected to each other electrically through the connector 300. Instead, the lower electrode 302 and the source electrode 202 of the thin film transistor B may be connected to each other through the connector 300.

The lower electrode 302 is the anode of the organic EL element 1, and is a transparent thin film made of indium tin oxide (ITO), indium zinc oxide (IZO), zinc oxide (ZnO) or the like. ITO is preferred because, for example, high transparency, and high conductivity can be achieved.

For the hole transport layer 303, the light-emitting layer 304, and the electron transport layer 305, conventionally-known materials for organic EL elements can be used as is.

The upper electrode 306 is a film composed of a layer of lithium fluoride (LiF) having a film thickness of 5 nm to 20 nm and a layer of aluminum (Al) having a film thickness of 50 nm to 200 nm. For example, vapor deposition may be use to form the film.

When producing a bottom emission type organic EL element, the upper electrode 306 of the organic EL element 1 may be configured to have optical reflectivity. Thereby, the upper electrode 306 can reflect in the display side direction light generated by the organic EL element A and traveled toward the upper side as the opposite direction to the display side. Since the reflected light is also utilized for a display purpose, the emission efficiency of the organic EL element can be improved.

[Method of Manufacturing Display Element, Optical Element, or Illumination Element]

Another aspect of the present disclosure relates to a method of manufacturing a display element, an optical element, or an illumination element. In one or a plurality of embodiments, the production method according to the present disclosure is a method of manufacturing the display element, the optical element, or the illumination element according to the present disclosure. Further, in one or a plurality of embodiments, the manufacturing method according to the present disclosure is a method of manufacturing a display element, an optical element, or an illumination element, which includes the steps of applying the polyamide resin composition according to the present disclosure onto a base; forming a polyamide film after the application step; and forming the display element, the optical element, or the illumination element on a surface of the polyamide film not in contact with the base. The production method according to the present disclosure may further include the step of de-bonding, from the base, the display element, the optical element, or the illumination element formed on the base.

<Non-Limiting Embodiment of Method of Producing Organic EL Element>

As one embodiment of the method of manufacturing a display element according to the present disclosure, hereinafter, one embodiment of a method of manufacturing an organic EL element will be described with reference to the drawing.

A method of producing the organic EL element 1 shown in FIG. 4 includes a fixing step, a gas barrier layer production step, a thin film transistor production step, an organic EL layer production step, a sealing step and a de-bonding step. Hereinafter, each step will be described in detail.

1. Fixing Step

In the fixing step, the transparent resin substrate 100 is fixed onto the base 500. A way to fix the transparent resin substrate to the base is not particularly limited. For example, an adhesive may be applied between the base 500 and the transparent substrate, or a part of the transparent resin substrate 100 may be fused and attached to the base 500 to fix the transparent resin substrate 100 to the base 500. Further, as the material of the base, glass, metal, silicon, resin or the like is used, for example. These materials may be used alone or in combination of two or more as appropriate. Furthermore, the transparent resin substrate 100 may be attached to the base 500 by applying a releasing agent or the like onto the base 500 and placing the transparent resin substrate 100 on the applied releasing agent. In one or a plurality of embodiments, the polyamide film 100 is formed by applying the polyamide resin composition according to the present disclosure onto the base 500, and drying the applied polyamide resin composition.

2. Gas Barrier Layer Production Step

In the gas barrier layer production step, the gas barrier layer 101 is produced on the transparent resin substrate 100. A way to produce the gas barrier layer 101 is not particularly limited, and a known method can be used.

3. Thin Film Transistor Production Step

In the thin film transistor production step, the thin film transistor B is produced on the gas barrier layer. A way to produce the thin film transistor B is not particularly limited, and a known method can be used.

4. Organic EL Layer Production Step

The organic EL layer production step includes a first step and a second step. In the first step, the flattened layer 301 is formed. The flattened layer 301 can be formed by, for example, spin-coating, slit-coating, or ink-jetting a photosensitive transparent resin. At that time, an opening needs to be formed in the flattened layer 301 so that the connector 300 can be formed in the second step. Generally, the flattened layer has a film thickness of, but is not limited to, about 100 nm to 2 μm.

In the second step, first, the connector 300 and the lower electrode 302 are formed at the same time. Sputtering, vapor deposition, ion plating or the like may be used to form the connector 300 and the lower electrode 302. Generally, each of these electrodes has a film thickness of, but is not limited to, about 50 nm to 200 nm. Subsequently, the hole transport layer 303, the light-emitting layer 304, the electron transport layer 305, and the upper electrode 306 as the cathode of the organic EL element 1 are formed. To form these components, a method such as vapor deposition, application, or the like can be used as appropriate in accordance with the materials to be used and the laminate structure. Further, irrespective of the explanations given in this example, other layers may be chosen from known organic layers such as a hole injection layer, an electron transport layer, a hole blocking layer and an electron blocking layer as needed and be used to configuring the organic layers of the organic EL element 1.

5. Sealing Step

In the sealing step, the organic EL layer C is sealed with the sealing member 307 from top of the upper electrode 306. For example, a glass material, a resin material, a ceramics material, a metal material, a metal compound or a composite thereof can be used to form the sealing member 307, and a material best suited to the sealing member 307 can be chosen as appropriate.

6. De-Bonding Step

In the de-bonding step, the produced organic EL element 1 is de-bonded from the base 500. To implement the de-bonding step, for example, the organic EL element 1 may be physically stripped from the base 500. At that time, the base 500 may be provided with a de-bonding layer, or a wire may be inserted between the base 500 and the display element to remove the organic EL element. Further, examples of other methods of de-bonding the organic EL element 1 from the base 500 include the following: forming a de-bonding layer on the base 500 except at ends, and cutting, after the production of the element, the inner part from the ends to remove the element from the base; providing a layer of silicon or the like between the base 500 and the element, and irradiating the silicon layer with a laser to strip the element; applying heat to the base 500 to separate the base 500 and the transparent substrate from each other; and removing the base 500 using a solvent. These methods may be used alone or any of these methods may be used in combination of two or more. Especially in one or a plurality of embodiments, the strength of adhesion between the polyamide film and the base can be controlled by a silane coupling agent, so that the organic EL element 1 can be physically stripped without using the complicated method such as described above.

[Display Device, Optical Device, and Illumination Device]

An aspect of the present disclosure relates to a display device, an optical device, or an illumination device using the display element, the optical element, or the illumination element according to the present disclosure, or a method of manufacturing the display device, the optical device, or the illumination device. Examples of the display device include, but are not limited to, an imaging element; examples of the optical device include, but are not limited to, a photoelectric complex circuit; and examples of the illumination device include, but are not limited to, a TFT-LCD and OEL illumination.

[Method for Manufacturing Sensor Element]

In another aspect, the present disclosure relates to a method for manufacturing a sensor element, including steps (A) and (B) below;

(A) applying a polyamide solution according to the present disclosure onto a base so as to form a polyamide film on the base;
(B) forming a sensor element on the surface of the polyamide film.

For the base, the above-mentioned base can be used.

In the step (A) of the manufacturing method in this aspect, a laminated composite material can be formed. In one or a plurality of embodiments, the step (A) of the manufacturing method in this aspect includes steps (i) and (ii) below:

(i) applying the above-mentioned polyamide solution onto a base (see FIG. 1, step A);
(ii) heating the applied polyamide solution after the step (i) so as to form a polyamide film (see FIG. 1, step B).

The application in the step (i) and the heating temperature in the step (ii) may be set as mentioned above. The manufacturing method in this aspect may include, following the step (ii), a curing step (iii) to cure the polyamide film. The temperature and the time period for the curing can be set as mentioned above.

The formation of the sensor element in the step (B) of the manufacturing method in this aspect is not limited in particular, but it can be carried out appropriately for the sensor element for manufacturing an element that has been or will be manufactured.

In one or a plurality of embodiments, the manufacturing method in this aspect includes, following the step (B), a step (C) for de-bonding a formed sensor element from a glass plate. In the de-bonding step (C), the produced sensor element is de-bonded from a base. The de-bonding step can be carried out as mentioned above.

[Sensor Element]

In one or a plurality of embodiments, the present disclosure relates to a sensor element manufactured by the manufacturing method in this aspect. In one or a plurality of non-limiting embodiments, examples of the “sensor element” produced by the production method according to the present disclosure include a sensor element having a polyamide film formed from a polyamide solution used in the production method of the present disclosure. In one or a plurality of embodiments, examples of a “sensor element” produced by the production method according to the present disclosure include a sensor element that is formed on the surface of the polyamide film formed on a base. In one or a plurality of embodiments, the sensor element can be de-bonded from the base. In one or a plurality of non-limiting embodiments, examples of the “sensor element” include a sensor element for electromagnetic wave, a sensor element for magnetic field, a sensor element for capacitance change or a sensor element for pressure, examples of which include an image pickup element, a radiation sensor element, a photo sensor element, a magnetic sensor element, capacitive sensor element, touch sensor element, or pressure sensor element. In one or a plurality of embodiments, examples of the radiation sensor element include an X-ray sensor element. In one or a plurality of embodiments, the sensor element according to the present disclosure includes a sensor element that is manufactured by using the polyamide solution according to the present disclosure, and/or a sensor element that is manufactured by using the laminated composite material according to the present disclosure, and/or a sensor element that is manufactured by the process for manufacturing an element according to the present disclosure. Further, in one or a plurality of embodiments, forming of the sensor element according to the present disclosure includes forming of a photoelectric conversion element and a driver element.

[Input Device]

In one or a plurality of non-limiting embodiments, the “sensor element” produced by the production method according to the present disclosure can be used in an input device. In the present disclosure, in one or a plurality of embodiments, examples of an input device using the “sensor element” include an optical input device, an image pickup input device, a magnetic input device, a capacitive input device and a pressure input device. In one or a plurality of non-limiting embodiments, examples of the input device include a radiation image pickup device, a visible light image pickup device, a magnetic sensor device touch panel, fingerprint authentication panel, light emitting material using piezoelectric device. In one or a plurality of embodiments, examples of the radiation image pickup device include an X-ray pickup device. Further, in one or a plurality of non-limiting embodiments, an input device according to the present disclosure may have a function of an output device such as display function.

<Non-Limiting Embodiment for Sensor Element>

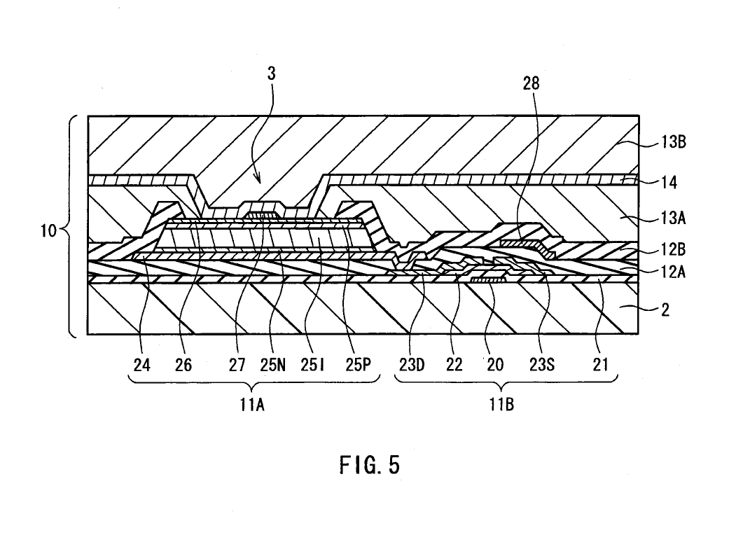

Hereinafter, an embodiment of sensor element that can be manufactured by the manufacturing method in this aspect is explained with reference to FIG. 5.

FIG. 5 is a schematic cross-sectional view showing a sensor element 1 according to an embodiment. The sensor element 1 has a plurality of pixels. This sensor element 1 is produced by forming, on a surface of a substrate 2, a pixel circuit including a plurality of photodiodes 11A (photoelectric conversion element) and a thin film transistor (TFT) 11B as the driver element for the photodiodes 11A. This substrate 2 is the polyamide film to be formed on a base (not shown) by the step (A) of the manufacturing method in this aspect. And in the step (B) of the manufacturing method in this aspect, the photodiodes 11A (photoelectric conversion element) and the thin film transistor 11B as the driver element for the photodiodes 11A are formed.

A gate insulating film 21 is provided on the substrate 2, and it is composed of a single layer film of any one of a silicon oxide (SiO₂) film, a silicon oxynitride (SiON) film and a silicon nitride (SiN) film for example, or two or more of them. A first interlayer insulating film 12A is provided on the gate insulating film 21, and it is composed of a silicon oxide film or a silicon nitride film etc. This first interlayer insulating film 12A functions also as a protective film (passivation film) to cover the top of the thin film transistor 11B described below.

(Photodiode 11A)

The photodiode 11A is disposed on a selective region of the substrate 2 via the gate insulating film 21 and the first interlayer insulating film 12A. Specifically, the photodiode 11A is prepared by laminating, on the first interlayer insulating film 12A, a lower electrode 24, a n-type semiconductor layer 25N, an i-type semiconductor layer 251, a p-type semiconductor layer 25P and an upper electrode 26 in this order. The upper electrode 26 is an electrode for supplying a reference potential (bias potential) during a photoelectric conversion for example to the above-mentioned photoelectric conversion layer, and thus it is connected to a wiring layer 27 as a power supply wiring for supplying the reference potential. This upper electrode 26 is composed of a transparent conductive film of ITO (indium tin oxide) or the like, for example.

(Thin Film Transistor 11B)

The thin film transistor 11B is composed of a field effect transistor (FET), for example. This thin film transistor 11B is prepared by forming on the substrate 2 a gate electrode 20 composed of titanium (Ti), Al, Mo, tungsten (W), chromium (Cr) and the like, and by forming the above-mentioned gate insulating film 21 on this gate electrode 20. Further, a semiconductor layer 22 is formed on the gate insulating film 21, and the semiconductor layer 22 has a channel region. On this semiconductor layer 22, a source electrode 23S and a drain electrode 23D are formed. Specifically, here, the drain electrode 23D is connected to the lower electrode 24 in each photodiode 11A while the source electrode 23S is connected to a relay electrode 28.

Furthermore in the sensor element 1, on such photodiode 11A and the thin film transistor 11B, a second interlayer insulating film 12B, a first flattened film 13A, a protective film 14 and a second flattened film 13B are provided in this order. Further in this first flattened film 13A, an opening 3 is formed corresponding to the region for forming the photodiode 11A.

On the sensor element 1, for example, a wavelength conversion member is formed to produce a radiograph device.

The present disclosure can relate to the following one or a plurality of embodiments.

<1> A polyamide solution comprising an aromatic polyamide and a solvent,

wherein a dimension change gap between a cast film produced by casting the polyamide solution on a glass plate and the cast film after being subjected to a heat treatment is −50 μm to 50 μm, −40 μm to 40 μm, −30 μm to 30 μm, −20 μm to 20 μm, or −15 μm to 15 μm.

<2> The polyamide solution according to <1>, wherein the dimension change gap is determined by Thermo Mechanical Analysis (TMA).
<3> The polyamide solution according to <1> or <2>, wherein a temperature of the heat treatment is higher than or equal to a temperature deducted 100° C. from a glass transition temperature (Tg) of the cast film.
<4> The polyamide solution according to any one of <1> to <3>, wherein the temperature of the heat treatment is less than a glass transition temperature (Tg) of the cast film.
<5> The polyamide solution according to any one of <1> to <4>, wherein tan δ of β relaxation peak of the cast film produced by casting the polyamide solution on the glass plate, which is expressed in a region of a lower temperature in comparison with a relaxation, is 0.15 or less, 0.12 or less, 0.10 or less, 0.08 pr less, 0.07 or less, or 0.05 or less.
<6> The polyamide solution according to any one of <1> to <5>, wherein diamine monomer used for synthesis of the aromatic polyamide comprises a diamine monomer represented by general formula (X):

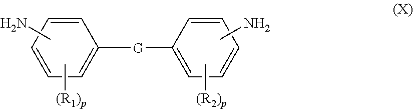

wherein p=1 to 4,

wherein R₁ and R₂ are independently selected from the group consisting of hydrogen, halogen (fluorine, chlorine, bromine, and iodine), alkyl, substituted alkyl such as halogenated alkyl, nitro, cyano, thioalkyl, alkoxy, substituted alkoxy such as halogenated alkoxy, aryl, substituted aryl such as halogenated aryl, alkyl ester, and substituted alkyl ester such as halogenated alkyl ester, and combinations thereof and, where R₁ and R₂ are plural, each R₁ and/or R₂ can be same or different, and

wherein G is a organic group.

<7> The polyamide solution according to <6>, wherein G is selected from the group consisting of a SO₂ group; 9,9-fluorene group; substituted 9,9-fluorene group; and an OZO group, where Z is 9,9-bisphenylfluorene group or substituted 9,9-bisphenylfluorene group.
<8> The polyamide solution according to <6> or <7>, wherein the diamine monomer represented by the general formula (X) is selected from the group consisting of FDA (9,9-bis(4-aminophenyl)fluorine), FFDA (9,9-bis(3-fluoro-4-aminophenyl)fluorine) and DDS (diaminodiphenyl sulfone).
<9> The polyamide solution according to any one of <6> to <8>, wherein the diamine monomer represented by the general formula (X) is DDS (diaminodiphenyl sulfone).
<10> The polyamide solution according to any one of <1> to <9>, wherein the cast film produced by casting the polyamide solution on a glass plate has a glass transition temperature (Tg) of less than 365° C.
<11> The polyamide solution according to any one of <1> to <9>, wherein the cast film produced by casting the polyamide solution on a glass plate has a glass transition temperature (Tg) of 365° C. or more.
<12> The polyamide solution according to any one of <1> to <11>, wherein a total light transmittance of D line (Sodium line) of the cast film produced by casting the polyamide solution on a glass plate is 80% or more.
<13> The polyamide solution according to any one of <1> to <12>, wherein a coefficient of thermal expansion (CTE) of the cast film produced by casting the polyamide solution on a glass plate is 10.0 ppm/° C. or higher, 12.5 ppm/° C. or more, 15.0 ppm/° C. or more, 17.5 ppm/° C. or more, 20 ppm/° C. or more, 30 ppm/° C. or more, 45 ppm/° C. or more, 50 ppm/° C. or more, or, 53 ppm/° C. or more.
<14> The polyamide solution according to any one of <1> to <13>, wherein retardation (Rth) at a wavelength of 400 nm in thickness direction of a cast film produced by casting the polyamide solution on a glass plate is 100 nm or less.
<15> The polyamide solution according to any one of <6> to <14>, wherein the diamine monomer represented by general formula (X) makes up in total more than 5.0 mol %, 7.0 mol % or more, 10.0 mol % or more, 15.0 mol % or more, 20 mol % or more, 30 mol % or more, 40 mol % or more, 45 mol % or more, or, 47 mol % or more of the whole monomer used for synthesis of the aromatic polyamide.
<16> The polyamide solution according to any one of <1> to <15>, wherein diamine monomer used for synthesis of the aromatic polyamide comprises a diamine monomer represented by the general formula (X) below, and the diamine monomer represented by the general formula (X) makes up in total more than 80 mol %, 85 mol % or more, 90 mol % or more, or, 95 mol % or more of the whole diamine monomer used for the synthesis:

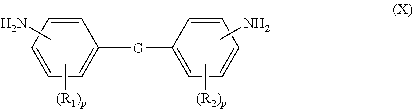

wherein p=1 to 4,

wherein R₁ and R₂ are independently selected from the group consisting of hydrogen, halogen (fluorine, chlorine, bromine, and iodine), alkyl, substituted alkyl such as halogenated alkyl, nitro, cyano, thioalkyl, alkoxy, substituted alkoxy such as halogenated alkoxy, aryl, substituted aryl such as halogenated aryl, alkyl ester, and substituted alkyl ester such as halogenated alkyl ester, and combinations thereof and where R₁ and R₂ are plural, each R₁ and/or R₂ can be same or different, and wherein G is a organic group.

<17> The polyamide solution according to <16>, wherein G is selected from the group consisting of a SO₂ group; 9,9-fluorene group; substituted 9,9-fluorene group; and an OZO group, where Z is 9,9-bisphenylfluorene group or substituted 9,9-bisphenylfluorene group.
<18> The polyamide solution according to any one of <1> to <17>, wherein e diamine monomer used for synthesis of the aromatic polyamide comprises at least one diamine monomer selected from the group consisting of FDA (9,9-bis(4-aminophenyl) fluorene), FFDA (9,9-bis(3-fluoro-4-aminophenyl) fluorene) and DDS (diaminodiphenyl sulfone), and the FDA, the FFDA, and the DDS make up in total more than 80 mol %, 85 mol % or more, 90 mol % or more, or, 95 mol % or more of the whole diamine monomer used for the synthesis.
<19> The polyamide solution according to any one of <16> to <18>, wherein the DDS makes up 30 mol % or more, 40 mol % or more, 45 mol % or more, 50 mol % or more, 60 mol % or more, or, 65 mol % or more of the whole diamine monomer used for the synthesis.
<20> The polyamide solution according to any one of <16> to <19>, wherein the amount of DDS (mol %) is the highest among two or more diamine monomers used for the synthesis.
<21> The polyamide solution according to any one of <1> to <20>, wherein at least one of the constitutional units of the aromatic polyamide has a free carboxyl group.
<22> The polyamide solution according to any one of <1> to <21>, further containing a multifunctional epoxide.
<23> The polyamide solution according to <22>, wherein the multifunctional epoxide is an epoxide having two or more glycidyl groups, or an epoxide having two or more alicyclic structures.
<24> The polyamide solution according to <22> or <23>, wherein the multifunctional epoxide is selected from the group expressed by general formulae (I) to (IV):

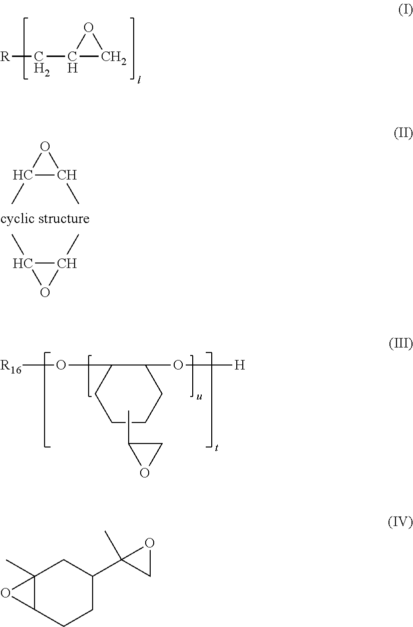

in the formula (I), l represents the number of glycidyl groups, wherein R is selected from the group consisting of:

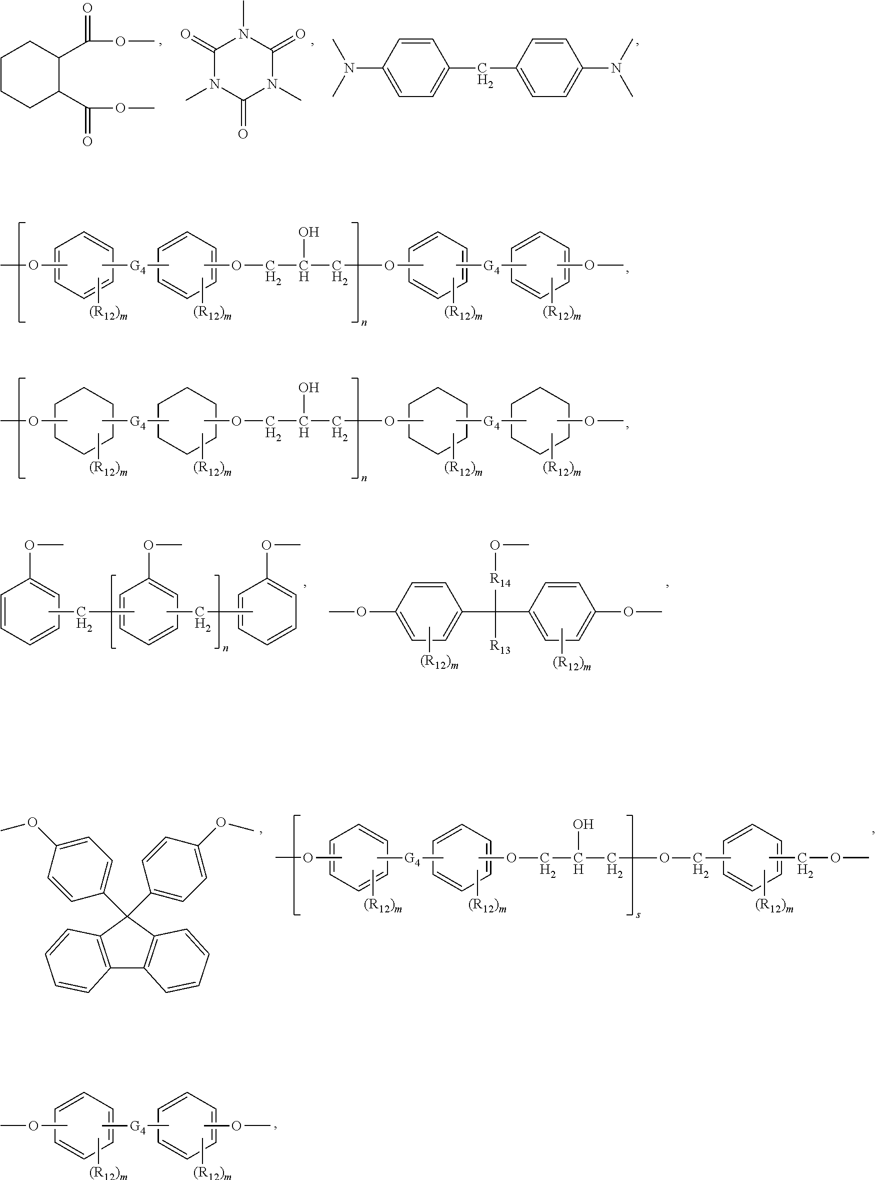

and a combination thereof, wherein m is 1 to 4, wherein n and s represent the average unit numbers, each of which is in the range of 0 to 30 independently, wherein R₁₂ is selected from the group consisting of hydrogen, halogen (fluorine, chlorine, bromine, and iodine), alkyl, substituted alkyl such as halogenated alkyl, nitro, cyano, thioalkyl, alkoxy, substituted alkoxy such as a halogenated alkoxy, aryl, or substituted aryl such as halogenated aryl, alkyl ester and substituted alkyl ester such as halogenated alkyl ester, and combinations thereof, wherein G₄ is selected from the group consisting of a covalent bond; a CH₂ group; a C(CH₃)₂ group; a C(CF₃)₂ group; a C(CX₃)₂ group, where X is a halogen; a CO group; an O atom; a S atom; a SO₂ group; a Si (CH₃)₂ group; 9,9-fluorene group; substituted 9,9-fluorene group; and an OZO monomer used for synthesis of the aromatic polyamide is group, where Z is an aryl group or substituted aryl group, such as phenyl group, biphenyl group, perfluorobiphenyl group, 9,9-bisphenylfluorene group, and substituted 9,9-bisphenylfluorene group, wherein R₁₃ is either hydrogen or a methyl group, and wherein R₁₄ is a divalent organic group,

in the formula (II), the cyclic structure is selected from the group consisting of

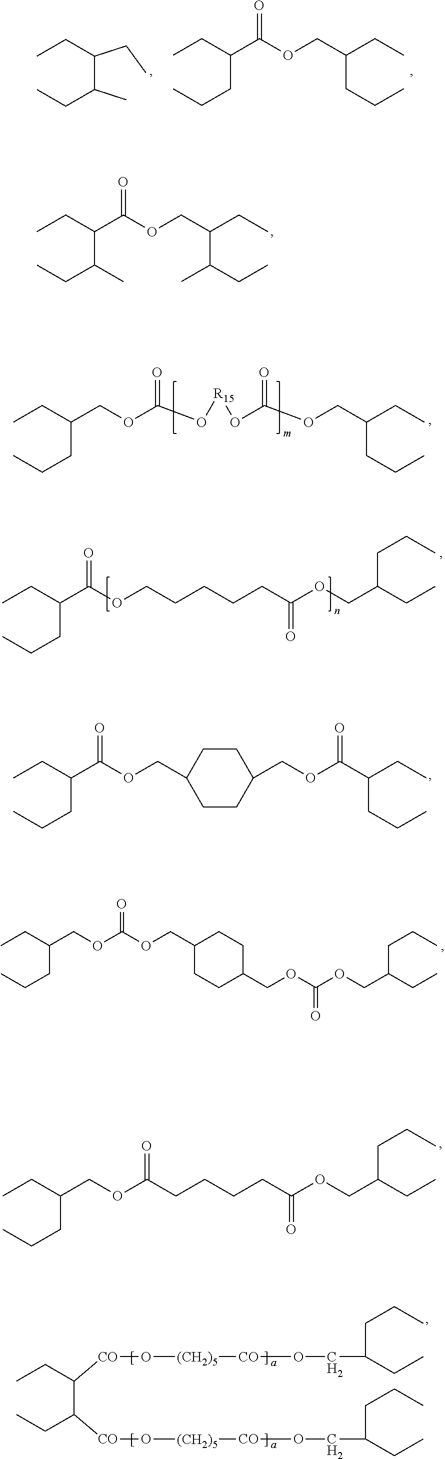

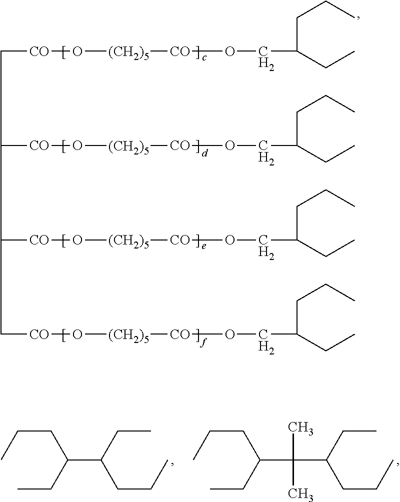

and a combination thereof, wherein R₁₅ is a C2-C18 alkyl chain, which may be a linear chain, a branched chain, or a chain including a cycloalkane structure, wherein m and n are the average unit numbers, each of which is in the range of 1 to 30 independently, and wherein each of a, b, c, d, e and f is the number in the range of 0 to 30 independently, and

in the formula (III), R₁₆ is a C2-C18 alkyl chain, which may be a linear chain, a branched chain, or a chain including cycloalkane, and wherein t and u are the average unit numbers, each of which is in the range of 0 to 30 independently.

<25> The polyamide solution according to any one of <1> to <24> for use in the method for manufacturing a display element, an optical element, an illumination element or a sensor element, comprising the steps of:

a) applying a polyamide solution onto a base;

b) forming a polyamide film on the base after the applying step (a); and

c) forming the display element, the optical element, the illumination element or the sensor element, on the surface of the polyamide film.

<26> A laminated composite material, comprising a glass plate and a polyamide resin layer;

wherein the polyamide resin layer is laminated on one surface of the glass plate; and wherein the polyamide resin is a polyamide resin produced by casting the polyamide solution according to any one of <1> to <25> on a glass plate.

<27> The laminated composite material according to <26>, wherein warpage deformation of the laminated composite material measured by a displacement sensor is −500 μm or more and 500 μm or less, −300 μm or more and 300 μm or less, −200 μm or more and 200 μm or less, −150 μm or more and 150 μm or less, −80 μm or more and 80 μm or less, or, −75 μm or more and 75 μm or less.
<28> A method for manufacturing a display element, an optical element, an illumination element or a sensor element, comprising the steps of

a) applying the polyamide solution according to any one of <1> to <25> onto a base;

b) forming a polyamide film on the base after the applying step (a); and

c) forming the display element, the optical element, the illumination element, or the sensor element on the surface of polyamide film.

<29> A display element, an optical element, an illumination element or a sensor element manufactured by the method according to <28>.

### Example 1

Polyamide solutions (Solutions 1 to 10) were prepared by using the ingredients listed in Table 1 and indicated below. For the films formed by using the thus prepared polyamide solutions, the thickness direction retardation (Rth), transmittance of D line (Sodium line), dimension change gap, amount of curvature/warpage, coefficient of thermal expansion (CTE), glass transition temperature (Tg), and tan δ of β relaxation peak were measured in the following manner.

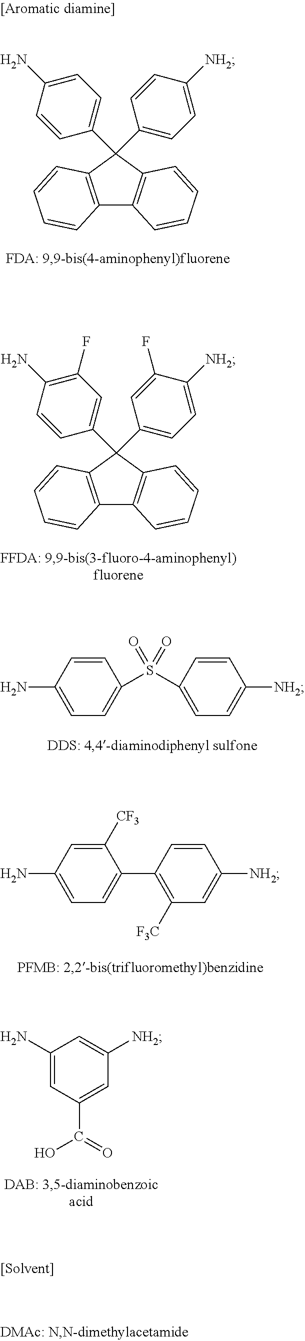 [SMILES: Nc1ccc(C2(c3ccc(N)cc3)c3ccccc3-c3ccccc32)cc1 ; Nc1ccc(C2(c3ccc(N)c(F)c3)c3ccccc3-c3ccccc32)cc1F ; Nc1ccc(S(=O)(=O)c2ccc(N)cc2)cc1 ; Nc1ccc(-c2ccc(N)cc2C(F)(F)F)c(C(F)(F)F)c1 ; Nc1cc(N)cc(C(=O)O)c1]

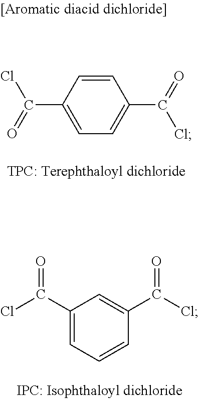 [SMILES: O=C(Cl)c1ccc(C(=O)Cl)cc1 ; O=C(Cl)c1cccc(C(=O)Cl)c1]

### [Trapping Reagent]

PrO: Propylene Oxide

[Preparation of Polyamide Solution]

This example illustrates the general procedure for the preparation of Solution 2 containing 5% by weight of a copolymer of TPC, IPC, DDS, PFMB and DAB (10%/90%/30%/65%/5% mol ratio) in DMAc.

To a 250 ml three necked round bottom flask, equipped with a mechanical stirrer, a nitrogen inlet and outlet, are added DDS (0.745 g, 0.0030 mol), PFMB (2.081 g, 0.0065 mol), DAB (0.0761 g, 0.0005 mol) and DMAc (75 ml). After the DDS, PFMB and DAB dissolved completely, PrO (1.7 g, 0.03 mol) was added to the solution. The solution is cooled to 0° C. After the addition, under stirring, TPC (0.203 g, 0.001 mol) and IPC (1.827 g, 0.009 mol) were added to the solution, and the flask inner wall was washed with DMAc (1.5 ml). After two hours, benzoyl chloride (0.032 g, 0.23 mmol) was added to the solution and stirred for another two hours, thereby the Solution 2 was obtained.

Similarly to Solution 2, Solution 1 and Solutions 3 to 10 were prepared as 5 wt % polyamide solutions.

[Formation of Polyamide Films]

Polyamide solutions 1 to 10 prepared were casted on a glass substrate to form films, and the properties of each film were studied.

Each polyamide solution was applied onto a flat glass substrate (10 cm×10 cm, trade name: EAGLE XG from Corning Inc., USA) by spin coating. After drying the casted solution for 30 minutes or more at 60° C., the temperature was increased from 60° C. to 330° C. or 350° C., and the temperature was kept at 330° C. or 350° C. for 30 minutes or 60 minutes under vacuum or in an inert atmosphere to cure the film. The polyamide films 1-10 obtained each had a thickness of about 10 μm.

The properties of the polyamide films (Rth at wavelengths of 400 and 550 nm, total light transmittance (Tt), CTE, Tg, and tan δ of β relaxation peak) were measured in the below-described manners. Table 1 provides the results.

[Laminated Composite Material]

A polyamide solution was applied onto a flat glass substrate (370 mm×470 mm×0.7 mm, trade name: EAGLE XG, from Corning Inc., USA) by spin coating. After drying the casted solution for 30 minutes or more at 60° C., the temperature was increased from 60° C. to 330° C. or 350° C., and the temperature was kept at 330° C. or 350° C. for 30 minutes or 60 minutes under vacuum or in an inert atmosphere to cure the film. Thereby, laminated composite materials 1-10 each having a polyamide film about 10 μm in thickness laminated on the glass substrate were obtained.

The warpage curvature (amount of curvature) of these laminated composite materials was measured in the below-described manners. Table 1 provides the results.

[Retardation in Thickness Direction (Rth)]

Retardations in thickness direction of each of the polyamide films 1-10 at wavelengths of 400 nm and 550 nm were calculated as follows. With a retardation measuring device (KOBRA-21ADH from Oji Scientific Instruments), the retardation between 0° and 40° was measured using the wavelength dispersion measurement mode (light at 479.2 nm, 545.4 nm, 630.3 nm, and 748.9 nm), and the retardation between 0° and 40° at 400 nm was calculated using the Sellmeier equation, and from the value and refractive index obtained, Rth at an arbitrary wavelength (400 nm and 550 nm in this case) was calculated.

[Total Light Transmittance]

The total light transmittance (Tt) of each polyamide film in D line (Sodium line) was measured using a haze meter (NDH-2000, from Nippon Denshoku Industries Co., Ltd.).

[Coefficient of Thermal Expansion, Dimension Change Gap (Polyamide Films 1-4 and 8-9)

As the coefficient of thermal expansion (CTE) of each of the polyamide films 1-4 and 8-9, an average coefficient of thermal expansion and dimension change gap was measured by a thermal mechanical analyzer (TMA) in the following manner were adopted.

First, the temperature of samples was increased from 25° C. to 270° C. at a rate of 20° C./min in a nitrogen atmosphere, followed by keeping the temperature at 270° C. for 5 minutes, and then cooled to 25° C. at a rate of 20° C./min, and the average coefficient of thermal expansion of the samples undergone the method was measured using TMA4000SA from Bruker AXS. The difference in the length of each sample before and after the treatment was determined as the dimension change gap. The distance between the chucks was 10 mm, width of each sample was 5 mm, and the load was 2 g. The measurement was carried out in the tensile mode. The average coefficient of thermal expansion was determined using the following formula.

### [TMA Conditions]

Sample dimension: 10 mm (distance between chucks)×5 mm (width)

### Temperature Conditions:

Initial temperature: 25° C., warming rate: 20° C./min.

Maximal temperature: 270° C.

Hold temperature•time: 270° C./5 min.

Cooling rate: 20° C./min.

Temperature after cooling: 25° C.

Loading: 2.0 g

Method for calculating CTE and dimension change gap

Average coefficient of thermal expansion (ppm/K)=((L250−L25)/L25)/(250−25)×10⁶

Dimension change gap (μm)=(Sample length before heating (25° C.))−(Sample length after heating (25° C.))

L250: Sample length at 270° C.
L25: Sample length at 25° C.

[Coefficient of Thermal Expansion, Dimension Change Gap (Polyamide Films 5-7 and 10)]

As the coefficient of thermal expansion (CTE) and dimension change gap of each of the polyamide films 5-7 and 10, an average coefficient of thermal expansion and dimension change gap was measured by a thermal mechanical analyzer (TMA) in the following manner were adopted.

First, the temperature of samples was increased from 25° C. to 340° C. at a rate of 20° C./min in a nitrogen atmosphere, followed by keeping the temperature at 340° C. for 5 minutes, and then cooled to 25° C. at a rate of 20° C./min, and the average coefficient of thermal expansion of the samples undergone the method was measured using TMA4000SA from Bruker AXS. The difference in the length of each sample before and after the treatment was determined as the dimension change gap. The distance between the chucks was 10 mm, width of each sample was 5 mm, and the load was 2 g. The measurement was carried out in the tensile mode. The average coefficient of thermal expansion was determined using the following formula.

### [TMA Conditions]

Sample dimension: 10 mm (distance between chucks)×5 mm (width)

### Temperature Conditions:

Initial temperature: 25° C., warming rate: 20° C./min.

Maximal temperature: 340° C.

Hold temperature•time: 340° C./5 min.

Cooling rate: 20° C./min.

Temperature after cooling: 25° C.

Loading: 2.0 g

Method for calculating CTE and dimension change gap: identical to those for polyamide films 1-4 and 8-9

[Glass Transition Temperature (Tg)]

For the polyamide films 1-10, the dynamic viscoelasicity from 25° C. to 400° C. was measured at warming rate of 5° C./min., tensile force of 10 mN, and under an atmospheric condition with a dynamic mechanical analyzer (Rheovibron DDV-01FP, from A&D Company Limited), and the maximal value of tan 5 at measurement was set to Tg.

[tan δ of β Relaxation Peak]

For the polyamide films 1-10, the dynamic viscoelasicity from 25° C. to 400° C. was measured at warming rate of 5° C./min., tensile force of 10 mN, and under an atmospheric condition with a dynamic mechanical analyzer (Rheovibron DDV-01FP, from A&D Company Limited), and tan δ of β relaxation peak that is expressed in a region of temperature lower than that of the α relaxation at measurement was measured.

[Warpage Evaluation]

Warpage of the prepared laminated composite materials 1-10 was measured with a laser displacement sensor (LT9010, from KEYENCE). The difference between the maximal value and the minimal value of height was set as the amount of curvature.

TABLE 1

| | | Solution Nos. | | | | | | | | | |
|---|---|---|---|---|---|---|---|---|---|---|---|
| | | 1 | 2 | 3 | 4 | 5 | 6 | 7 | 8 | 9 | 10 |
| Formulation | TPC | 10 | 10 | 10 | 10 | 30 | 100 | 100 | 100 | 10 | 10 |
| (mol %) | IPC | 90 | 90 | 90 | 90 | 70 | 0 | 0 | 0 | 90 | 90 |
| | DDS | 0 | 30 | 50 | 80 | 0 | 0 | 0 | 0 | 0 | 0 |
| | FDA | 0 | 0 | 0 | 0 | 70 | 45 | 60 | 75 | 0 | 0 |
| | FFDA | 0 | 0 | 0 | 0 | 0 | 0 | 0 | 0 | 30 | 50 |
| | PFMB | 95 | 65 | 45 | 15 | 25 | 50 | 35 | 20 | 65 | 45 |
| | DAB | 5 | 5 | 5 | 5 | 5 | 5 | 5 | 5 | 5 | 5 |
| Cure Temp. (° C.)/Time (min) | | 330/60 | 330/60 | 330/60 | 330/60 | 350/30 | 350/30 | 350/30 | 350/30 | 330/60 | 330/60 |
| Thickness (um) | | 10 | 10 | 10 | 10 | 10 | 10 | 10 | 10 | 7.7 | 10.8 |
| Rth | 400 nm | 91 | 42 | 31 | 0 | 72 | 510 | 361 | 298 | 36 | 34 |
| | 550 nm | 64 | 36 | 18 | 0 | 72 | 433 | 301 | 249 | 27 | 28 |
| Tt (%) | D line | 89.3 | 88.8 | 88.3 | 87.7 | 87 | 87 | 87 | 87 | 88.8 | 88.5 |
| Dimension Change Gap (um) | | 51.3 | 31.8 | 21.5 | 7.58 | 19 | 42 | 32 | 27 | 43 | 37 |
| Amount of Curvature (um) | | 209 | 167 | 113 | 81 | 117 | 84 | 81 | 81 | <200* | <200* |
| CTE | 50-250° C. | 35 | 43 | 49 | 54 | 48 | 19 | 26 | 33 | 43 | 45 |
| (ppm/° C.) | | | | | | | | | | | |
| Tg (° C.) | DMA tanδ max | 340 | 336 | 338 | 338 | 367 | 411 | 420 | 423 | 341 | 342 |
| tanσ at | DMA tanδ | 0.138 | 0.096 | 0.076 | 0.05 | 0.06 | 0.08 | 0.06 | 0.04 | 0.096 | 0.068 |
| β relaxation | (under Tg) | | | | | | | | | | |
| peak | | | | | | | | | | | |

As shown in Table 1, in each of the polyamide solutions 2-10 where the dimension change gaps were in the range of −50 μm to 50 μm, the amount of curvature was suppressed in comparison with the polyamide solution 1.

### Example 2

Polyamide solutions (Solutions 21-28) were prepared by using the ingredients as shown in Table 2. And, the properties of the films formed by using the prepared polyamide solutions and the warpage deformation (amount of curvature) of laminated composite materials formed by using the prepared polyamide solutions were measured similarly to Example 1.

[Preparation of Polyamide Solution]

This example illustrates the general procedure for the preparation of Solution 25 containing 5% by weight of a copolymer of TPC, IPC, DDS, FDA and DAB (30%/70%/80%/15%/5% mol ratio) in DMAc.

To a 250 ml three necked round bottom flask, equipped with a mechanical stirrer, a nitrogen inlet and outlet, are added DDS (1.987 g, 0.0080 mol), FDA (0.523 g, 0.0015 mol), DAB (0.0761 g, 0.0005 mol) and DMAc (75 ml). After the DDS, the FDA and the DAB dissolved completely, PrO (1.7 g, 0.03 mol) were added to the solution. The solution is cooled to 0° C. Under stirring, TPC (0.609 g, 0.003 mol) and IPC (1.421 g, 0.007 mol) was added to the solution, and the flask inner wall was washed with DMAc (1.5 ml). After two hours, benzoyl chloride (0.032 g, 0.23 mmol) was added to the solution and stirred for another two hours, thereby the Solution 25 was obtained.

Similarly to Solution 25, Solution 21-24 and 26-28 were prepared as 5 wt % polyamide solutions.

[Formation of Polyamide Films]

Each of Solutions 21 to 28 as the polyamide solution prepared was applied onto a flat glass substrate (10 cm×10 cm, trade name: EAGLE XG, from Corning Inc., USA) by spin coating. After drying the casted solution for 30 minutes or more at 60° C., the temperature was increased from 60° C. to 350° C., and the temperature was kept at 350° C. for 30 minutes under vacuum or in an inert atmosphere to cure the film. The polyamide films 21-28 obtained each had a thickness of about 10 μm. The properties of the polyamide films 21-28 (Rth at wavelengths of 400 and 550 nm, D line (Sodium line) and total light transmittance (Tt) at wavelength of 365 nm, dimension change gap, coefficient of thermal expansion (CTE), Tg, and, tan δ of β relaxation peak) were measured in the above-described manners. The CTE and the dimension change gap were measured under the measurement conditions for the polyamide films 5-7 and 10. Table 2 provides the results.

[Laminated Composite Material]

Each of the prepared polyamide solutions 21-28 was applied onto a flat glass substrate (370 mm×470 mm×0.7 mm, trade name: EAGLE XG, from Corning Inc., USA) by spin coating. After drying for 30 minutes or more at 60° C., the temperature was increased from 60° C. to 350° C., and the temperature was kept at 350° C. for 30 minutes under vacuum or in an inert atmosphere to cure the film. Thereby, laminated composite materials 21-28 each having a polyamide film about 10 μm in thickness laminated on the glass substrate were obtained. The warpage deformation (amount of curvature) of these laminated composite materials was measured in the above-described manners. Table 2 provides the results.

TABLE 2

| | | Solution Nos. | | | | | | | |
|---|---|---|---|---|---|---|---|---|---|
| | | 21 | 22 | 23 | 24 | 25 | 26 | 27 | 28 |
| Formulation | TPC | 30 | 30 | 30 | 30 | 30 | 0 | 0 | 0 |
| (mol %) | IPC | 70 | 70 | 70 | 70 | 70 | 100 | 100 | 100 |
| | DDS | 0 | 30 | 50 | 65 | 80 | 50 | 65 | 80 |
| | FDA | 95 | 65 | 45 | 30 | 15 | 45 | 30 | 15 |
| | FFDA | 0 | 0 | 0 | 0 | 0 | 0 | 0 | 0 |
| | PFMB | 0 | 0 | 0 | 0 | 0 | 0 | 0 | 0 |
| | DAB | 5 | 5 | 5 | 5 | 5 | 5 | 5 | 5 |
| CureTemp. (° C.)/Time (min) | | 350/30 | 350/30 | 350/30 | 350/30 | 350/30 | 350/30 | 350/30 | 350/30 |
| Thickness (um) | | 11.4 | 10.9 | 10.1 | 10.1 | 10 | 10.1 | 10 | 10.8 |
| Rth | 400 nm | 78 | 96 | 100 | 72 | 71 | 49 | 30 | 26 |
| | 550 nm | 54 | 64 | 73 | 47 | 48 | 37 | 21 | 18 |
| Tt (%) | D line | 87 | 87 | 87 | 87 | 87 | 87 | 87 | 87 |
| | @365 nm | 5 | 7 | 11 | 15 | 21 | 34 | 38 | 38 |
| Dimension Change Gap (um) | | 15 | 14 | 10 | 10 | 13 | 10 | 11 | 10 |
| Amount of Curvature (um) | | 138 | 108 | 77 | 75 | 36 | 101 | 52 | 43 |
| CTE (ppm/° C.) | 50-250° C. | 49 | 51 | 53 | 55 | 53 | 53 | 55 | 54 |
| Tg (° C.) | DMA tanδmax | 378 | 369 | 367 | 360 | 354 | 358 | 356 | 348 |
| tan δ at | DMA tanδ | 0.02 | 0.032 | 0.034 | 0.039 | 0.038 | 0.038 | 0.034 | 0.032 |
| βrelaxation peak | (under Tg) | | | | | | | | |

As shown in Table 2, in the polyamide solutions 21-28 where the sum of DDS and FDA is 95 mol %, the dimension change gap was within the range of −50 μm to 50 μm, i.e., the amount of curvature was suppressed. Further, in the polyamide solutions 21-25, apparently there was a tendency that the amount of curvature was reduced as the percentage of DDS increased. A similar tendency was found also for the polyamide solutions 26-28.

### Example 3

### Preparation of Polyamide Solutions 29-31

To the solutions 21, 25 and 27, TG (triglycidyl isocyanurate) of 5% by weight with respect to polyamide was added respectively, which were stirred further for 2 hours to prepare polyamide solutions 29-31. Using these polyamide solutions 29-31, similarly to Example 2, polyamide films and laminated composite materials were produced so as to measure the film characteristics and the amount of curvature. The results are shown in Table 3.

The solvent resistances of the films were observed visually after dipping the films in N-methyl-2-pyrrolidone (NMP) for 30 minutes at room temperature and then, they were rated against the standards below.

### [Rating]

Yes: not dissolved, and not swelled in solvent

TABLE 3

| | Solution Nos. | 29 | 30 | 31 |
|---|---|---|---|---|
| Formulation | TPC | 30 | 30 | 0 |
| (mol %) | IPC | 70 | 70 | 100 |
| | DDS | 0 | 80 | 65 |
| | FDA | 95 | 15 | 30 |
| | FFDA | 0 | 0 | 0 |
| | PFMB | 0 | 0 | 0 |
| | DAB | 5 | 5 | 5 |
| Epoxide | TG | 5 | 5 | 5 |
| (wt %) | | | | |
| Cure Temp.(° C.)/Time(min) | | 280/30 | 280/30 | 280/30 |
| Thickness (um) | | 10.3 | 10.9 | 10.8 |
| Rth | 400 nm | 180 | 191 | 194 |
| | 550 nm | 121 | 125 | 129 |
| Tt (%) | D line | 87 | 87 | 87 |
| | @365 nm | 3 | 8 | 17 |
| Dimension Change Gap | | 12 | 10 | 10 |
| Amount of Curvature (um) | | 125 | 32 | 52 |
| CTE | 50-250° C. | 43 | 45 | 46 |
| (ppm/° C.) | | | | |
| Tg(° C.) | DMA tanδ | 377 | 355 | 355 |
| | max | | | |
| tanδ at | DMA tanδ | 0.02 | 0.038 | 0.033 |
| βrelaxation | (under Tg) | | | |
| peak | | | | |

| | | | |
|---|---|---|---|
| Solvent resistance | Yes | Yes | Yes |

As shown in Table 3, the solutions 29-31 including epoxide provided film characteristics and warp suppression similar to those of the solutions 21, 25 and 27 even by lowering the curing temperature, and they exhibited excellent solvent resistance.

The embodiments have been described, hereinabove. It will be apparent to those skilled in the art that the above methods and apparatuses may incorporate changes and modifications without departing from the general scope of the present disclosure. It is intended to include all such modifications and alterations insofar as they come within the scope of the appended claims or the equivalents thereof. Although the description above contains much specificity, this should not be construed as limiting the scope of the disclosure, but as merely providing illustrations of some of the embodiments of the present disclosure. Various other embodiments and ramifications are possible within its scope.

Furthermore, notwithstanding that the numerical ranges and parameters setting forth the broad scope of the disclosure are approximations, the numerical values set forth in the specific examples are reported as precisely as possible. Any numerical value, however, inherently contain certain errors necessarily resulting from the standard deviation found in their respective testing measurements.

1. A polyamide solution comprising an aromatic polyamide and a solvent,
wherein a dimension change gap between a cast film produced by casting the polyamide solution on a glass plate and the cast film after being subjected to a heat treatment is −50 μm to 50 μm, −40 μm to 40 μm, −30 μm to 30 μm, −20 μm to 20 μm, or −15 μm to 15 μm.

2. The polyamide solution according to claim 1, wherein the dimension change gap is determined by Thermo Mechanical Analysis (TMA).

3. The polyamide solution according to claim 1, wherein a temperature of the heat treatment is higher than or equal to a temperature deducted 100° C. from a glass transition temperature (Tg) of the cast film.

4. The polyamide solution according to claim 1, wherein the temperature of the heat treatment is less than a glass transition temperature (Tg) of the cast film.

5. The polyamide solution according to claim 1, wherein tan δ of β relaxation peak of the cast film produced by casting the polyamide solution on the glass plate, which is expressed in a region of a lower temperature in comparison with α relaxation, is 0.15 or less, 0.12 or less, 0.10 or less, 0.08 pr less, 0.07 or less, or 0.05 or less.

6. The polyamide solution according to claim 1, wherein diamine monomer used for synthesis of the aromatic polyamide comprises a diamine monomer represented by general formula (X): 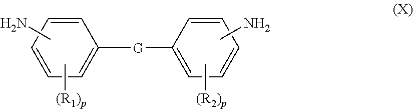
wherein p=1 to 4,
wherein R₁ and R₂ are independently selected from the group consisting of hydrogen, halogen, alkyl, substituted alkyl, nitro, cyano, thioalkyl, alkoxy, substituted alkoxy, aryl, substituted aryl, alkyl ester, and substituted alkyl ester, and combinations thereof and, where R₁ and R₂ are plural, each R₁ and/or R₂ can be same or different, and
wherein G is a organic group.

7. The polyamide solution according to claim 6, wherein G is selected from the group consisting of a SO₂ group; 9,9-fluorene group; substituted 9,9-fluorene group; and an OZO group, where Z is 9,9-bisphenylfluorene group or substituted 9,9-bisphenylfluorene group.

8. The polyamide solution according to claim 6, wherein the diamine monomer represented by the general formula (X) is selected from the group consisting of FDA (9,9-bis(4-aminophenyl)fluorine), FFDA (9,9-bis(3-fluoro-4-aminophenyl)fluorine) and DDS (diaminodiphenyl sulfone).

9. The polyamide solution according to claim 6, wherein the diamine monomer represented by the general formula (X) is DDS (diaminodiphenyl sulfone).

10. The polyamide solution according to claim 1, wherein the cast film produced by casting the polyamide solution on a glass plate has a glass transition temperature (Tg) of less than 365° C.

11. The polyamide solution according to claim 1, wherein the cast film produced by casting the polyamide solution on a glass plate has a glass transition temperature (Tg) of 365° C. or more.

12. The polyamide solution according to claim 1, wherein a total light transmittance of D line (Sodium line) of the cast film produced by casting the polyamide solution on a glass plate is 80% or more.

13. The polyamide solution according to claim 1, wherein a coefficient of thermal expansion (CTE) of the cast film produced by casting the polyamide solution on a glass plate is 10.0 ppm/° C. or more, 12.5 ppm/° C. or more, 15.0 ppm/° C. or more, 17.5 ppm/° C. or more, 20 ppm/° C. or more, 30 ppm/° C. or more, 45 ppm/° C. or more, 50 ppm/° C. or more, or, 53 ppm/° C. or more.

14. The polyamide solution according to claim 1, wherein retardation (Rth) at a wavelength of 400 nm in thickness direction of a cast film produced by casting the polyamide solution on a glass plate is 100 nm or less.

15. The polyamide solution according to claim 6, wherein the diamine monomer represented by general formula (X) makes up in total more than 5.0 mol %, 7.0 mol % or more, 10.0 mol % or more, 15.0 mol % or more, 20 mol % or more, 30 mol % or more, 40 mol % or more, 45 mol % or more, or, 47 mol % or more of the whole monomer used for synthesis of the aromatic polyamide.

16. The polyamide solution according to claim 1, wherein diamine monomer used for synthesis of the aromatic polyamide comprises a diamine monomer represented by the general formula (X) below, and the diamine monomer represented by the general formula (X) makes up in total more than 80 mol %, 85 mol % or more, 90 mol % or more, or, 95 mol % or more of the whole diamine monomer used for the synthesis: 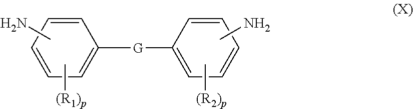
wherein p=1 to 4,
wherein R₁ and R₂ are independently selected from the group consisting of hydrogen, halogen, alkyl, substituted alkyl, nitro, cyano, thioalkyl, alkoxy, substituted alkoxy, aryl, substituted aryl, alkyl ester, and substituted alkyl ester, and combinations thereof and where R₁ and R₂ are plural, each R₁ and/or R₂ can be same or different, and
wherein G is a organic group.

17. The polyamide solution according to claim 1, wherein G is selected from the group consisting of a SO₂ group; 9,9-fluorene group; substituted 9,9-fluorene group; and an OZO group, where Z is 9,9-bisphenylfluorene group or substituted 9,9-bisphenylfluorene group.

18. The polyamide solution according to claim 1, wherein diamine monomer used for synthesis of the aromatic polyamide comprises at least one selected from the group consisting of FDA (9,9-bis(4-aminophenyl) fluorene), FFDA (9,9-bis(3-fluoro-4-aminophenyl) fluorene) and DDS (diaminodiphenyl sulfone), and the FDA, the FFDA, and the DDA make up in total more than 80 mol %, 85 mol % or more, 90 mol % or more, or, 95 mol % or more of the whole diamine monomer used for the synthesis.

19. The polyamide solution according to claim 16, wherein the DDS makes up 30 mol % or more, 40 mol % or more, 45 mol % or more, 50 mol % or more, 60 mol % or more, or, 65 mol % or more of the whole diamine monomer used for the synthesis.

20. The polyamide solution according to claim 16, wherein the amount of DDS (mol %) is the highest among two or more diamine monomers used for the synthesis.

21. The polyamide solution according to claim 1, wherein at least one of the constitutional units of the aromatic polyamide has a free carboxyl group.

22. The polyamide solution according to claim 1, further containing a multifunctional epoxide.

23. The polyamide solution according to claim 22, wherein the multifunctional epoxide is an epoxide having two or more glycidyl groups, or an epoxide having two or more alicyclic structures.

24. The polyamide solution according to claim 22, wherein the multifunctional epoxide is selected from the group expressed by general formulae (I) to (IV): 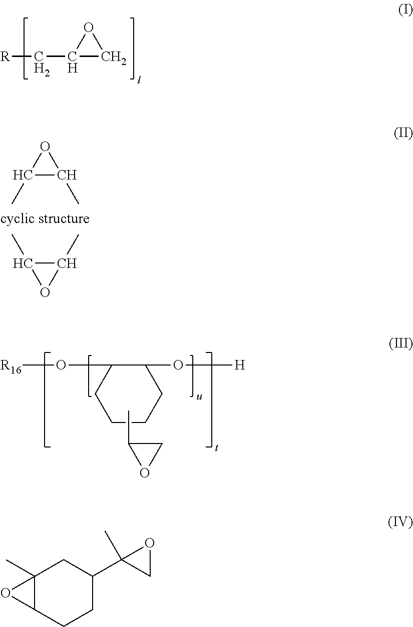
in the formula (I), l represents the number of glycidyl groups, wherein R is selected from the group consisting of: 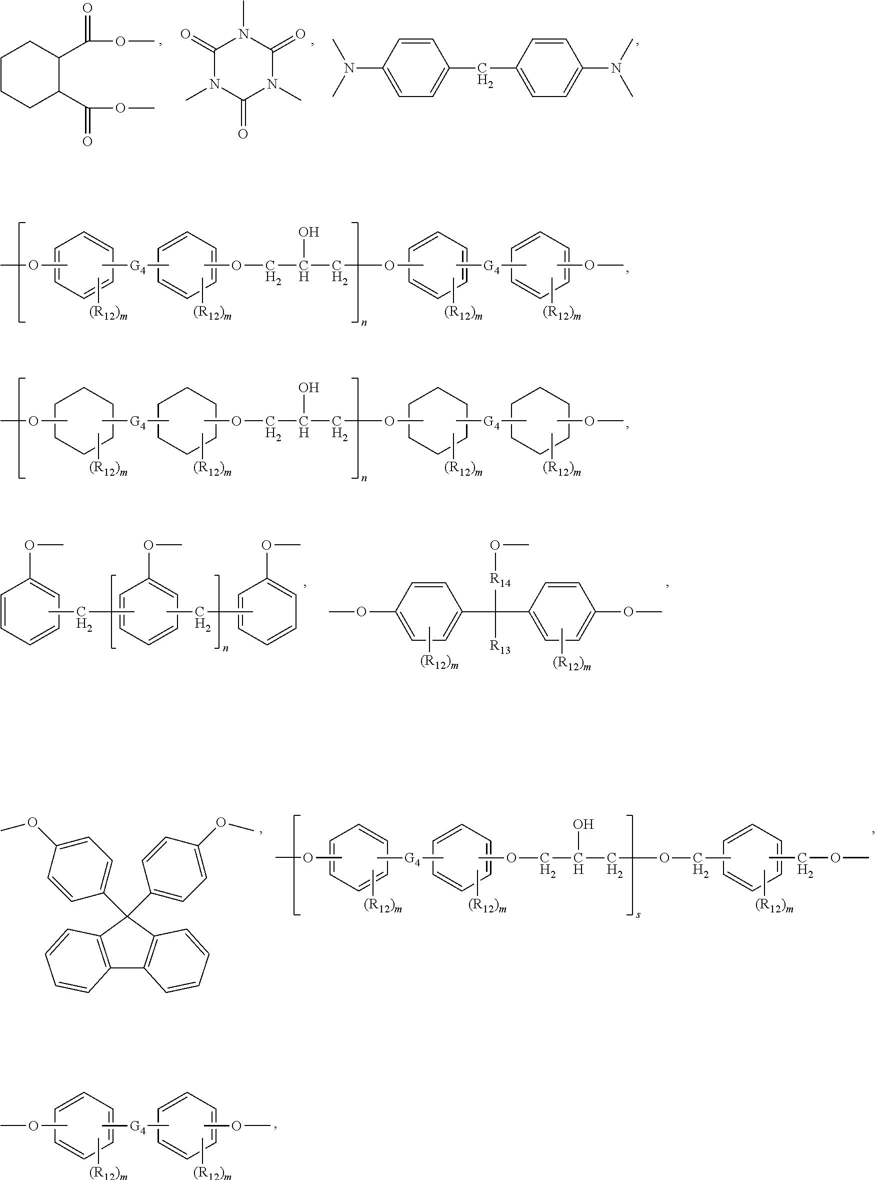
and a combination thereof, wherein m is 1 to 4, wherein n and s represent the average unit numbers, each of which is in the range of 0 to 30 independently, wherein R₁₂ is selected from the group consisting of hydrogen, halogen (fluorine, chlorine, bromine, and iodine), alkyl, substituted alkyl such as halogenated alkyl, nitro, cyano, thioalkyl, alkoxy, substituted alkoxy such as a halogenated alkoxy, aryl, or substituted aryl such as halogenated aryl, alkyl ester and substituted alkyl ester such as halogenated alkyl ester, and combinations thereof, wherein G₄ is selected from the group consisting of a covalent bond; a CH₂ group; a C(CH₃)₂ group; a C(CF₃)₂ group; a C(CX₃)₂ group, where X is a halogen; a CO group; an O atom; a S atom; a SO₂ group; a Si (CH₃)₂ group; 9,9-fluorene group; substituted 9,9-fluorene group; and an OZO group, where Z is an aryl group or substituted aryl group, such as phenyl group, biphenyl group, perfluorobiphenyl group, 9,9-bisphenylfluorene group, and substituted 9,9-bisphenylfluorene group, wherein R₁₃ is either hydrogen or a methyl group, and wherein R₁₄ is a divalent organic group,
in the formula (II), the cyclic structure is selected from the group consisting of: 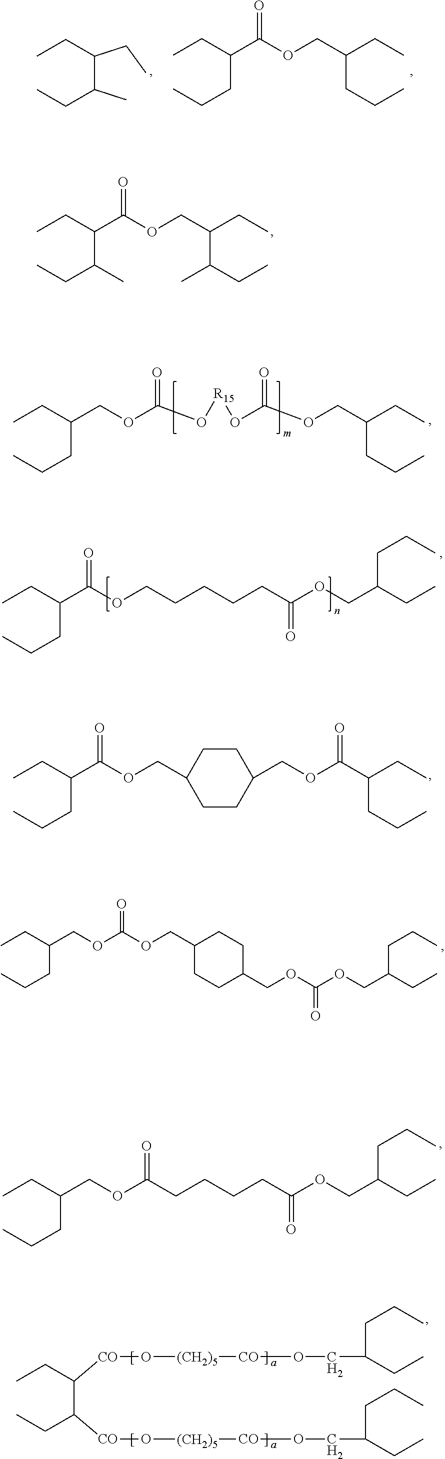 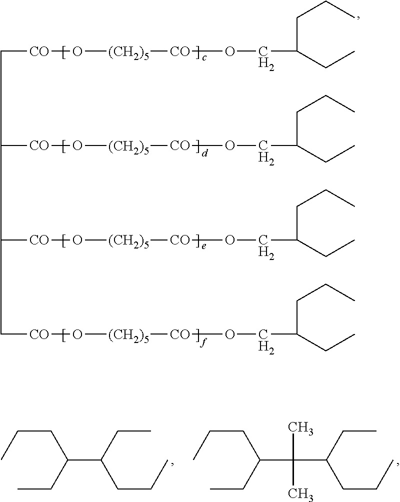
and a combination thereof, wherein R₁₅ is a C2-C18 alkyl chain, which may be a linear chain, a branched chain, or a chain including a cycloalkane structure, wherein m and n are the average unit numbers, each of which is in the range of 1 to 30 independently, and wherein each of a, b, c, d, e and f is the number in the range of 0 to 30 independently, and
in the formula (III), R₁₆ is a C2-C18 alkyl chain, which may be a linear chain, a branched chain, or a chain including cycloalkane, and wherein t and u are the average unit numbers, each of which is in the range of 0 to 30 independently.

25. The polyamide solution according to claim 1 for use in the method for manufacturing a display element, an optical element, an illumination element or a sensor element, comprising the steps of
a) applying a polyamide solution onto a base;
b) forming a polyamide film on the base after the applying step (a); and
c) forming the display element, the optical element, the illumination element or the sensor element, on the surface of the polyamide film.

26. A laminated composite material, comprising a glass plate and a polyamide resin layer;
wherein the polyamide resin layer is laminated on one surface of the glass plate; and the polyamide resin is a polyamide resin produced by casting the polyamide solution according to claim 1 on a glass plate.

27. The laminated composite material according to claim 26, wherein warpage deformation of the laminated composite material measured by a displacement sensor is −500 μm or more and 500 μm or less, −300 μm or more and 300 μm or less, −200 μm or more and 200 μm or less, −150 μm or more and 150 μm or less, −80 μm or more and 80 μm or less, or, −75 μm or more and 75 μm or less.

28. A method for manufacturing a display element, an optical element, an illumination element or a sensor element, comprising the steps of
a) applying the polyamide solution according to claim 1 onto a base;
b) forming a polyamide film on the base after the applying step (a); and
c) forming the display element, the optical element, the illumination element, or the sensor element on the surface of polyamide film.

29. A display element, an optical element, an illumination element or a sensor element manufactured by the method according to claim 28.
